(19) United States
(12) Patent Application Publication
(10) Pub. No.: US 2015/0301317 A1
(43) Pub. Date: Oct. 22, 2015

(54) INFRARED CAMERA APPARATUS

(71) Applicant: TAMRON CO., LTD, Saitama-shi (JP)

(72) Inventors: Yuko Watanabe, Saitama-shi (JP); Setsu Sato, Saitama-shi (JP)

(73) Assignee: TAMRON CO., LTD, Saitama-shi (JP)

(21) Appl. No.: 14/686,919

(22) Filed: Apr. 15, 2015

(30) Foreign Application Priority Data
Apr. 16, 2014 (JP) 2014-084652

(51) Int. Cl. G02B 13/14

(52) U.S. Cl. CPC G02B 13/14

(57) ABSTRACT

The infrared camera apparatus incorporates an infrared lens system that retains high resolution power and yet is successfully reduced in a required volume of infrared lens material that is hard to obtain and expensive, so as to attain a compact and cost-reduced infrared camera apparatus incorporating such an infrared lens system. The infrared lens system has at least a single Fresnel lens piece that has at least one of its opposite sides formed in a Fresnel surface. The Fresnel lens piece is made of a lens material of which transmissivity to light waves of one or more monowavelength(s) within an available wavelength range from 3000 nm to 14000 nm is 35% or higher when it takes a shape of 4-mm thickness uncoated parallel flat plate.

### FIELD OF THE INVENTION

The present invention relates to infrared camera apparatuses, and more particularly, to infrared camera apparatuses capable of focusing infrared rays emitted from objects so as to create infrared images and take pictures.

### BACKGROUND OF THE INVENTION

Infrared camera apparatuses have recently found a more variety of uses including human surveillance sensors (human detecting sensors) for on-vehicle instruments, automatic doors, air conditioners, and the like, as well as infrared thermography, surveillance apparatuses, industrial measurement hardware, and medical measuring instruments.

In comparison with lens materials suitable for visible spectrum, however, substances, such as germanium, zinc selenide, chalcogenide glass, and the like, suitable for infrared rays of wavelength ranging from 3000 nm (3 μm) to 14000 nm (14 μm) are very expensive primarily because it is hard to mine ore from which these substances are obtained, and hence, the reduction in number and dimensions of component lens pieces leading to the reduction in manufacturing costs is strongly desired.

Incorporating a lens piece with a Fresnel surface in favor of more element-reduced and compact design is well known. Specifically, one specimen known in the art is an infrared lens system that has two Fresnel lens pieces incorporated, each having a Fresnel surface on one side and a flat surface on the other side so as to work like a convex lens, and satisfies two sets of optical conditions expressed by mathematical formulae (see, for example, Patent Document 1 listed below).

Another infrared lens system known in the art is that which has at least two spherical lens pieces and at least a single thin flat lens piece that has one of the opposite surfaces formed in a Fresnel lens (see, for example, Patent Document 2 listed below). This patent document also discloses a variation of the infrared lens system where the flat lens piece has one of the opposite surfaces formed in a diffraction grating.

As to visible spectrum lens systems, also, some of the prior art discloses an arrangement where a Fresnel surface is incorporated for the purpose of the reduction in number and dimensions of their component lens pieces. Specifically, one specimen known in the art is a wide angle photographing lens that includes a first lens piece of negative refractive power and a second lens piece of positive refractive power arranged in series closer to an object foremost where the first lens piece has its surface of incidence formed in a Fresnel surface while the second lens piece has its surface of incidence formed in a Fresnel surface and its surface of exit formed in an aspheric surface (see, for example, Patent Document 3 listed below).

Another prior art specimen of the visible spectrum lens systems designed to incorporate a Fresnel surface for the purpose of a reduction in number and dimensions of their component lens pieces is a wide angle photographing lens that includes a first lens piece of negative refractive power and a second lens piece of positive refractive power arranged in series closer to an object foremost where the first lens piece has at least one of the opposite surfaces formed in a Fresnel surface, with a reference spherical surface divided into separate curved Fresnel lens facets, while the second lens piece has at least one of the opposite surfaces formed in an aspherical surface. The Fresnel lens facets shaped in annular and concentric segments have their respective widths varied from one to another (see, for example, Patent Document 4 listed below).

Moreover, still another well-known variation of the visible spectrum lens system with a Fresnel surface incorporated is a photographing lens that includes a lens unit having at least one of surfaces shaped in an aspherical surface and at least one of the remaining surfaces closer to an object to photograph and to the image plane formed in a Fresnel surface (see Claim 1 of Patent Document 5 listed below).

Regarding the camera lens in Document 5, a variation of the lens unit is described as a composite lens of first and second lens pieces cemented together (see Claim 2 of Patent Document 5).

Further another well-known variation of the visible spectrum lens system with a Fresnel surface incorporated is a photographing lens that includes a lens unit having its rear surface closer to the image plane formed in a Fresnel surface and at least one of front and rear surfaces closer to an object to photograph and to the image plane formed with integral diffraction optics (see, for example, Patent Document 6).

### LIST OF THE CITED PATENT DOCUMENTS OF THE RELATED ART

### <Document 1>

JPN Patent No. 3758072

### <Document 2>

JPN Preliminary Pub. of Unexamined Pat. Appl. No. H10-301024

### <Document 3>

JPN Preliminary Pub. of Unexamined Pat. Appl. No. H06-230275

### <Document 4>

JPN Preliminary Pub. of Unexamined Pat. Appl. No. H07-043607

### <Document 5>

JPN Preliminary Pub. of Unexamined Pat. Appl. No. 2002-55273

### <Document 6>

JPN Preliminary Pub. of Unexamined Pat. Appl. No. 2002-350723

The aforementioned prior art visible spectrum lens systems, when used in camera apparatuses suitable for the visible spectrum range to which resolution as much as 100 lines per millimeter or even higher is recommended, encounter a significant reduction in resolution due to adverse effects of a diffracted image developed in relation with the varied widths or grating pitches of the annular Fresnel lens facets and the wavelength of the incident beams and/or due to adverse effects of flare caused by level differences at interfaces between pairs of the adjacent annular Fresnel lens facets. Meanwhile, the visible spectrum camera apparatuses generally produce color pictures, and to that end, image pickup devices have arrays of R-, G-, B-color filters corresponding to arrays of pixels. The R-, G-, B-color filters provide for transmitted-light ranges within certain energy levels of peak wavelengths, so as to permit only the light waves ranging from 100 nm to several tens nm to pass through them. This results in photo-detecting pixels receiving the beams incident at restricted diffraction angles to form on the image plane a diffracted image bright and sharp to some extent, and also results in formation of a normal image and the diffracted image deviated in position from the normal image. This is why it is undesirable incorporating a Fresnel surface in visible spectrum imaging systems, and industrial uses of the Fresnel surface are limited to applications to illumination systems to which the aforementioned adverse effects of diffracted images and flare are negligible and applications to simple illuminated magnifiers to which high resolution power is not required.

On the other hand, as to infrared image pickup devices, their receiving optics receive light waves of every wavelength within certain wavelength ranges without separating the incident light into its component wavelengths. As a consequence, the incident light diffracted at considerably widely varied diffraction angles corresponding to the available wavelength ranges of the infrared image pickup devices is imaged on the infrared image pickup devices, being deviated in position from normal images thereon.

As will be recognized, the diffracted images are blurred images on the infrared image pickup devices, and emerge as dark and indistinct infrared images of diffracted light due to adverse effects of flare caused by level differences in interfaces between pairs of the adjacent annular Fresnel lens facets.

Infrared light waves ranging from 3000 nm to 14000 nm are 10 to 20 times as great in wavelength as visible spectrum light waves ranging from 400 nm to 700 nm, and lead to degradation of the limit of resolution of the optics. Image processing is effective in enhancing contrast of the whole image and restoring the resultant image from corrupting influences of diffraction as much as such influences are practically negligible.

The infrared lens system described in the cited Document 1, which has two Fresnel lens pieces each having a Fresnel surface on one side and a flat surface on the other side so as to work as a convex lens and satisfies two sets of optical conditions expressed by mathematical formulae, is designed so that as first a focal length of the entire lens system and that of each of the Fresnel lens pieces are determined, a radius of curvature and principal points of the Fresnel lens piece are accordingly determined. This resultantly brings about a problem that an aspherical profile of the Fresnel surface is the only parameter taken advantage of to compensate for aberrations, and the imaging is performed without sufficiently correcting aberrations, which, in turn, leads to a failure in attaining a desired resolution power.

The infrared lens system described in the cited Document 2, which has at least two spherical lens pieces and at least a single thin flat lens piece that has one of the opposite surfaces formed in a Fresnel lens, is designed so that two of the lens pieces are spherical lenses, and such a lens system requires a greater amount of infrared lens material hard to obtain and expensive and achieves only a disappointing extent of reduction in the manufacturing cost. Supposedly, there remains a problem with such a lens system that spherical aberration can be corrected to some extent, but astigmatism and comatic aberration cannot sufficiently be.

The cemented lens unit described in Claim 2 of the cited Document 5, if it were applied to the infrared camera apparatus of the present invention so as to compensate for chromatic aberration, would permit a lens designer a very few kinds of the infrared lens material, and an application of a composite lens formed by cementing more than one lens pieces of different infrared lens materials is not an easy strategy for correcting chromatic aberration. In addition, no infrared ray transmitting cement exists. Thus, the technical manner of cementing a pair of convex and concave lens pieces together as in the cited Document 5 is actually impossible to apply to the infrared lens system.

Moreover, the cemented lens unit described in Claim 2 of the cited Document 5, if applied to the infrared camera apparatus of the present invention so as to compensate for chromatic aberration, would encounter a critical difficulty in the manufacturing process. To cement two lens pieces together, one of them that serves as a base element, namely, a lens A, is fixed, and then, the other or a lens B is moved relative to the lens A and aligned with the lens A in such a manner as a synthetic precision of light transmission axis alignment of the cemented pair of the lenses A and B or an axial alignment precision of the separate lenses A and B hypothetically regarded as a single lens unit is enhanced. Actually, however, an amount of optical shift/tilt of the lens B relative to the lens A is, since influenced by the axial alignment precision of the separate lenses A and B, inevitably increased. As a result, lens flare, which is caused by diffracted light from the annular Fresnel lens facets in a Fresnel surface of the lens B and by level differences in interfaces between pairs of the adjacent annular Fresnel lens facets, emerges somewhere inadvertently deviated in the image plane, and the influence of the increased optical shift/tilt in the Fresnel surface of the lens B is so significant as brightness and sharpness of the resultant image is deteriorated.

### SUMMARY OF THE INVENTION

The present invention is made to overcome the aforementioned disadvantages of the prior art infrared camera apparatuses, especially, the prior art infrared lens systems for the infrared camera apparatuses, and accordingly, it is an object of the present invention to provide an infrared lens system that retains high resolution power and yet is successfully reduced in a required volume of infrared lens material that is hard to obtain and expensive, so as to attain a compact and cost-reduced infrared camera apparatus incorporating the same.

In accordance with the present invention, an infrared camera apparatus incorporates an infrared lens system that comprises at least a single Fresnel lens piece having at least one of the opposite sides formed in a Fresnel surface.

The Fresnel lens piece in the infrared lens system is made of a lens material of which transmissivity to light waves of one or more monowavelengths within an available wavelength range from 3000 nm to 14000 nm is 35% or higher when it takes a shape of 4-mm thickness uncoated parallel flat plate. The Fresnel lens piece has its opposites sides respectively formed in curved surfaces, and the maximum value of angle θ between lines normal to the curved surfaces and the optical axis of the Fresnel lens piece meets the requirements defined in the formula (1) as follows:

5°≦θ≦65° (1)

In accordance with the present invention, the infrared lens system retains high resolution power and yet is successfully reduced in a required volume of the infrared lens material that is expensive primarily because it is hard to mine ore of the infrared lens material, so as to attain a compact and cost-reduced infrared camera apparatus incorporating the same.

The formula (1) is detailed below. The formula (1) expresses conditions where the infrared camera apparatus, which incorporates the infrared lens system that comprises at least a single Fresnel lens piece having at least one of the opposite sides formed in a Fresnel surface, can sufficiently compensate for aberrations induced therein, especially, spherical aberration, astigmatism, and comatic aberration.

When the maximum angle θ is smaller than the lower limit defined in the formula (1), the reference curvature of the Fresnel surface varied from one point to another causes only a small degree of variation in spherical aberration, astigmatism, and comatic aberration, which means that such aberrations cannot be fully corrected.

When the maximum angle θ exceeds the upper limit defined in the formula (1), the aberrations can be corrected indeed, but an increase in the number of the annular Fresnel lens facets is unavoidable to restrict the Fresnel lens piece to a certain thickness, and accordingly, the radial widths of the annular Fresnel lens facets are decreased. Consequently, lots of flare is caused by a level difference between the inner edge of one annular Fresnel lens facet and the outer edge of another adjacent inner annular Fresnel lens facet, namely, by sagging zones between the adjacent annular Fresnel lens facets, which prevents the formation of a bright and sharp image.

To assure the formation of a bright and sharp image, the above formula may preferably be replaced with 5°≦θ≦55°.

It is a requirement for a bright and sharp image that the infrared lens system is made of a lens material of which transmissivity to light waves of one or more monowavelengths within an available wavelength range from 3000 nm to 14000 nm is 35% or higher when it takes a shape of 4-mm thickness uncoated parallel flat plate.

Preferably, the infrared lens system may be made of a lens material of which transmissivity to light waves of one or more monowavelengths within an available wavelength range from 3000 nm to 14000 nm is 45% or higher when it takes a shape of 4-mm thickness uncoated parallel flat plate.

Further preferably, the infrared lens system may be made of a lens material of which transmissivity to light waves of one or more monowavelengths within an available wavelength range from 3000 nm to 14000 nm is 55% or higher when it takes a shape of 4-mm thickness uncoated parallel flat plate.

### Embodiment 1

In an infrared camera apparatus according to the present invention, the Fresnel surface of the Fresnel lens piece meets the requirement defined in the formula (2) as follows:

|X/R|≦0.17 (2)

where R is a radius of an outer circle surrounding the outermost one of the annular Fresnel lens facets concentrically divided in the Fresnel surface, and X is the maximum depth or distance in parallel with the optical axis from the center of the Fresnel surface to the most extended point or the peak of all peaks above the interfaces between pairs of the adjacent annular Fresnel lens facets.

The formula (2) is detailed below. The Fresnel lens piece, having its Fresnel surface divided more finely to have the increased number of the annular Fresnel lens facets, can enhance design resolution. Meanwhile, such a greater number of the annular Fresnel lens facets are prone to cause flare more due to level difference in interfaces between pairs of the adjacent annular facets and due to errors of machining the interfaces and resultantly reduce resolution power. Reversely, the Fresnel lens designed to have a smaller number of the annular Fresnel lens facets encounters difficulties in compensating for spherical aberration, astigmatism, comatic aberration, and the like.

The ‘level difference’ in any of the interfaces is a distance in parallel with the optical axis from the outer edge of one annular Fresnel lens facet to the inner edge of another adjacent outer annular Fresnel lens facet. FIG. 82 in the appended drawings shows a level difference SD (2012, 2014) in the interface between a pair of the adjacent annular Fresnel lens facets 2012 and 2014.

Many of the prior art Fresnel lenses are designed to have annular Fresnel lens facets of the same width, or of the same distance or level difference in parallel with the optical axis between the inner edge of an outer annular facet and the outer edge of an inner adjacent annular facet throughout the Fresnel surface, so that a line intersecting with apexes of all the annular Fresnel lens facets is a straight line orthogonal to the optical axis.

When the Fresnel lens is adapted to have a greater angle θ between lines normal to the curved surfaces of the annular Fresnel lens facets and the optical axis, the Fresnel lens is divided into the accordingly increased number of the annular facets to enhance design resolution power, but this results in flare being developed more due to level differenced in the interfaces between pairs of the adjacent annular facets and due to errors of machining the interfaces, which deteriorates resolution.

The formula (2) is advantageous in that, in order to suppress flare developed due to level differences in the interfaces between the annular Fresnel facets and due to errors of machining the interfaces, it limits the R-to-X ratio where R is a radius of an outer circle surrounding the outermost one of the annular Fresnel lens facets concentrically divided in the Fresnel lens surface, and X is the maximum depth or distance in parallel with the optical axis from the center of the Fresnel surface to the most extended point or the peak of all peaks above the interfaces between pairs of the adjacent annular Fresnel lens facets. When the ratio exceeds the upper limit defined in the formula (2), such a lens design is not so effective in reducing a volume of the infrared lens material, and the desired downsizing and cost reduction of the infrared camera apparatus cannot be achieved sufficiently.

As shown in FIG. 82 where a Fresnel lens 2000 has a Fresnel surface 2002 divided into a Fresnel lens center facet 2001 and concentric annular Fresnel lens facets 2010, 2012, and 2014, the maximum depth X is a distance in parallel with the optical axis from a point C centered in the Fresnel lens center facet 2001 to a point D extended the most or at the inner edge of the outermost of all the annular Fresnel lens facets.

The radius R is a radius of an outer circle surrounding the outermost one of the annular Fresnel lens facets divided concentrically with one another.

In the present invention, the Fresnel lens center facet 2001 is also regarded as one of the annular Fresnel lens facets of which inner edge surrounds a circle of 0-mm diameter.

### Embodiment 2

In another aspect of the present invention, the infrared camera apparatus is designed so that, in at least one of the Fresnel surfaces, 80% or more of the total number of the interfaces between pairs of the adjacent annular Fresnel lens facets meet the requirements as defined in the formula (3) as follows:

0.7≦P/N≦1.3 (3)

where T_{MAX} is the maximum of all the level differences in the interfaces, T_{MIN} is the minimum of all the level differences in the interfaces, P equals T_{MAX}/T_{MIN}, and N is an integer the closest to P.

The formula (3) defines a ratio of the level differences or altitudes in parallel with the optical axis in the interfaces between pairs of the adjacent annular Fresnel lens facets in the Fresnel surface. Such level differences in parallel with the optical axis in the interfaces between pairs of the adjacent annular Fresnel lens facets in the Fresnel surface work effectively to retain enhanced resolution power when a beam flux incident on the Fresnel surface has corresponding points of wave in unison (in phase) before and after transmitted through the annular Fresnel lens facets, or when the beam flux incident on the annular Fresnel lens facets with unison wavefront exits them, still keeping unison wavefront. For assuring an acceptable resolution, however, since the lens system is permitted to develop aberrations to a certain extent, depending upon the required resolving performance, the beam flux exiting may not have perfectly unison wavefront so far as 80% or more of the number of the interfaces within an effective aperture of the Fresnel surface meets the requirements defined in formula (3).

Preferably, a better resolution is assured under the following condition:

0.8≦P/N≦1.2

Further preferably, a better resolution is assured under the following condition:

0.85≦P/N≦1.15

Yet further preferably, a better resolution for a brighter and sharper image is assured under the following condition:

0.9≦P/N≦1.1

A point S is, as shown in FIG. 82, one of the interfaces between pairs of the adjacent annular Fresnel lens facets. The point or interface S (2012, 2014) between a pair of the adjacent annular facets 2012 and 2014 is raised or dropped by the level difference SD (2012, 2014) in parallel with the optical axis.

### Embodiment 3

In still another aspect of the present invention, the infrared camera apparatus is designed so that the Fresnel lens piece has Fresnel surfaces on the opposite sides.

Having the single lens with its opposite surfaces machined into Fresnel surfaces enables a reduction in volume of an expensive infrared lens material. The Fresnel lens design employs profiles of both the lens surfaces as parameters for compensating for aberrations, so as to increase freedom of an optical design, correct aberrations satisfactorily, and obtain high resolution images.

Further allowing for the difficulty in the manufacturing process as has been mentioned in relation with the cited Document 5 noted in paragraph [0008] herein, the lens design where a single lens has its opposite sides machined into a Fresnel surfaces enables the enhancement of optical shift/tilt precision in the Fresnel lens up to micro-machining precision of a lens processing machine and brings about quality images.

Such a design of the single lens with the dual Fresnel surfaces enables the resultant Fresnel lens to have a reduced distance between front and rear principal points. As a consequence, incident beams passing an outer peripheral area of the infrared lens system are as close to the optical axis as possible, and this enables a reduction in diameter of the lens pieces and thus a reduction in volume of the infrared lens material.

### Embodiment 4

In further another aspect of the present invention, the infrared camera apparatus is designed so that the annular Fresnel lens facets in the Fresnel surface have different radial widths from one another.

The Fresnel surface varied in radial width from one annular facet to another is also varied in diffraction angle at which light beams incident on the annular facets are diffracted. Making the radial width uneven in all the annular Fresnel lens facets makes the diffraction angle uneven and permits the incident beams on the annular facets to disperse, so as to alleviate adverse effects of flare developed by diffraction and then attain high resolution power.

Lens designs to make the diffraction angle uneven include a variation (1) where the Fresnel lens piece have its annular Fresnel lens facets gradually reduced in radial width from the center of the Fresnel surface to its outer periphery, a variation (2) where the annular Fresnel lens facets, which are gradually reduced in radial width from the center of the Fresnel surface to its outer periphery, partially have their radial widths reduced more than decrements of the gradual reduction or rather increased, a variation (3) where the annular Fresnel lens facets, which are gradually reduced in radial width from the center of the Fresnel surface to its outer periphery, partially appear as a repeated facet set(s), and a variation (4) where the annular Fresnel lens facets, which are gradually reduced in radial width from the center of the Fresnel surface to its outer periphery, have their radial widths reduced at varied rates.

Preferably, the annular Fresnel lens facets, which are gradually reduced in radial width from the center of the Fresnel surface to its outer periphery, partially have their radial widths reduced more than decrements of the gradual reduction.

The ‘radial width’ of any of the annular Fresnel lens facets is, as shown in FIG. 82, referred to a dimension like a radial width W(2012) of an annular Fresnel lens facet 2012.

### Embodiment 5

In yet another aspect of the present invention, the infrared camera apparatus is designed so that, in at least one of the Fresnel surfaces, 80% of the total number of the annular Fresnel lens facets have their radial widths sized to be 80 to 120% of the average radial width of all the annular Fresnel lens facets.

As has been mentioned, as the Fresnel surface is divided more finely into the increased number of the annular Fresnel lens facets while keeping the radial width even in all the annular Fresnel lens facets, the resultant Fresnel lens has its surface approximated more to a flat surface and is reduced in volume of the infrared lens material. With the increased number of the annular Fresnel lens facets, however, the beams incident on the annular facets are diffracted more, and flare is caused more due to level differences in the interfaces between pairs of the adjacent annular facets and due to errors of machining the interfaces, which results in resolution of images deteriorating.

To avoid such circumstances, or rather, to reduce the number of the annular Fresnel lens facets in simultaneous with a reduction in a required volume of the infrared lens material, 80% of the number of the annular Fresnel lens facets have their radial widths sized to be 80 to 120% of the average radial width of all the annular Fresnel lens facets. Restricting the annular Fresnel lens facets to such a range of the radial width facilitates micro-machining of the Fresnel surfaces and an efficient measurement of the Fresnel surfaces being machined.

### Embodiment 6

In another aspect of the present invention, the infrared camera apparatus is designed so that the annular Fresnel lens facets of the radial widths greater than the average radial width of all the annular Fresnel lens facets are within a centered zone extending over 75% or less of the effective aperture of the Fresnel surface.

As has been described, as it is divided into the increased number of the annular Fresnel lens facets, the Fresnel surface can approximate to a flat surface, and the resultant Fresnel lens can be reduced in volume of the infrared lens material. However, this brings about diffracted light more and causes flare to be developed more in the interfaces between pairs of the adjacent concentric annular facets, resulting in a reduction in resolving power. Hence, part where the profile is varied more significantly in the direction in parallel with the optical axis than it is in the direction orthogonal to the curved lens surface must be divided more finely into annular Fresnel lens facets while, reversely, part where the profile is varied less significantly in the direction in parallel with the optical axis than it is in the direction orthogonal to the curved lens surface must be divided more roughly so as to leave the lens surface smooth, thereby reducing a required volume of the infrared lens material.

Simultaneously, such a lens design enables a reduction in a degree of flare developed in the lens and is able to retain high resolution. In many of the lens designs, an influence of the lens material on a lens thickness is greater in the periphery of the lens surface than at the center. What affects resolving power the most is the light beams passing through the centered zone extending over approximately 70% of the effective aperture.

In view of the above, restricting a range where the Fresnel surface is divided into annular Fresnel lens facets, for example, leaving only the center area of the Fresnel surface undivided and smooth or dividing the center area into the reduced number of the annular Fresnel lens facets than the remaining portion surrounding the same enables a reduction in volume of the lens material as well as a reduction in a degree of flare developed, so as to obtain high resolution. In the Fresnel lens where the Fresnel surface has its center area more significantly varied in profile in the direction in parallel with the optical axis relative to the radial direction than the remaining portion surrounding the center area, a zone to divide into annular Fresnel lens facets may be chosen appropriately depending upon an intended shape of the lens surface, for example, by designating the center area of the lens surface to such a zone, so as to reduce a required volume of the infrared lens material and simultaneously reduce a degree of flare developed, thereby retaining high resolving power.

### Embodiment 7

In yet another aspect of the present invention, the infrared camera apparatus is designed so that the infrared lens system includes a plurality of the Fresnel surfaces, and the radial width of the annular Fresnel lens facets varies from one Fresnel surface to another.

As has already been stated above, as the Fresnel surface is divided into the increased number of the annular Fresnel lens facets while keeping the radial width even in all the annular Fresnel lens facets, the resultant Fresnel lens has its surface approximated more to a flat surface and is reduced in the required volume of the infrared lens material. With the increased number of the annular Fresnel lens facets, however, diffracted light is developed more, and flare is caused more due to level differences in the interfaces between pairs of the adjacent annular Fresnel lens facets and due to errors of machining the interfaces, which results in resolution of images deteriorating.

In order to alleviate the problem of adverse effects of diffracted light by means of dispersing light beams at uneven diffraction angles, the infrared camera apparatus is provided with two or more Fresnel surfaces, and at least two of the Fresnel surfaces have annular Fresnel lens facets of varied radial widths.

### Embodiment 8

In further another aspect of the present invention, the infrared camera apparatus incorporates the Fresnel lens piece formed with integral diffraction optics.

In the cited Document 6, a photographing lens design suitable for visible spectrum is disclosed where the lens unit has its second surface closer to the image plane formed in a Fresnel surface and has at least one of its first surface closer to the object and its second surface closer to the image plane formed with integral diffraction optics.

A diffraction angle is a function of the reference wavelength in relation with a width of a roof-shaped diffraction grating. A conjecture will now be given on the number of rulings of the diffraction grating required to obtain a certain diffraction angle: Visible spectrum with the reference wavelength of 550 nm requires rulings of the diffraction grating 7 times as many as infrared spectrum with the reference wavelength of 4000 nm and 20 times as many as that with the reference wavelength of 11000 nm. As the number of the rulings of the diffraction grating is increased, errors of machining the interfaces between pairs of the adjacent annular Fresnel lens facets are increased, and this accordingly deteriorates resolving power. Thus, the visible spectrum photographing lens described in the cited Document 6 fails to put the diffraction surface to an effective use.

The Fresnel lens piece formed with integral diffraction optics as provided in this embodiment is advantageous in that such a lens design can reduce the number of required diffraction optics and thus flare developed therein, and enables the compensation for chromatic aberration as well as other aberrations induced at the center or the periphery of images.

The present invention also provides a camera apparatus that incorporates a Fresnel lens piece divided concentrically into annular Fresnel lens facets where the one of the greatest level difference in the direction in parallel with the optical axis between its inner and outer edges is within a centered zone extending over 75% of the effective aperture of the Fresnel lens piece, and 80% or more of the total number of interfaces between pairs of the adjacent annular Fresnel lens facets meet the requirements defined in the formula (3) as follows:

0.7≦P/N≦1.3 (3)

where T_{MAX} is the maximum of all the level differences in the interfaces, T_{MIN} is the minimum of all the level differences in the interfaces, P equals T_{MAX}/T_{MIN}, and N is an integer the closest to P.

Some of embodiments of the camera apparatus according to the present invention will be described below.

### Embodiment 9

In one aspect of the present invention, the camera apparatus incorporates the Fresnel lens piece made of a lens material of which transmissivity to light waves within a wavelength range from 3000 nm to 14000 nm is 35% or higher when it takes a shape of 4-mm thickness uncoated parallel flat plate.

### Embodiment 10

In another aspect of the present invention, the camera apparatus incorporates the Fresnel lens piece that has a Fresnel surface meeting the requirement defined in the formula (2) as follows:

|X/R|≦0.17 (2)

where R is a radius of the outer circle surrounding the outermost one of the annular concentric Fresnel lens facets, and X is the maximum depth or distance in parallel with the optical axis from the center of the Fresnel surface to the most extended point or the peak of all peaks above the interfaces between pairs of the adjacent annular Fresnel lens facets.

### Embodiment 11

In still another aspect of the present invention, the camera apparatus incorporates the Fresnel lens piece that has its opposite sides respectively formed in curved surfaces.

### Embodiment 12

In further another aspect of the present invention, the camera apparatus incorporates the Fresnel lens piece that has its opposite sides respectively formed in curved surfaces, and the maximum value of angle θ between lines normal to the curved surfaces and the optical axis of the Fresnel lens piece meets the requirements defined in the formula (1) as follows:

5°≦θ≦65° (1)

### BRIEF DESCRIPTION OF THE DRAWINGS

FIG. 1 is a diagram illustrating an exemplary photographing lens system incorporated in a first embodiment of an infrared camera apparatus according to the present invention.

FIG. 2 is a cross-sectional view illustrating a first Fresnel surface of the exemplary photographing lens system in the first embodiment.

FIG. 3 is a cross-sectional view illustrating a second Fresnel surface of the photographing lens system in the first embodiment.

FIG. 4 is a graph showing spherical aberration induced in the photographing lens system in the first embodiment.

FIG. 5 is a graph showing astigmatism induced in the photographing lens system in the first embodiment.

FIG. 6 is a diagram illustrating another exemplary photographing lens system incorporated in a second embodiment of the infrared camera apparatus according to the present invention.

FIG. 7 is a cross-sectional view illustrating a first Fresnel surface of the photographing lens system in the second embodiment.

FIG. 8 is a cross-sectional view illustrating a second Fresnel surface of the photographing lens system in the second embodiment.

FIG. 9 is a cross-sectional view illustrating a fourth Fresnel surface of the photographing lens system in the second embodiment.

FIG. 10 is a cross-sectional view illustrating a fifth Fresnel surface of the photographing lens system in the second embodiment.

FIG. 11 is a graph showing spherical aberration induced in the photographing lens system in the second embodiment.

FIG. 12 is a graph showing astigmatism induced in the photographing lens system in the second embodiment.

FIG. 13 is a diagram illustrating another exemplary photographing lens system incorporated in a third embodiment of the infrared camera apparatus according to the present invention.

FIG. 14 is a cross-sectional view illustrating a second Fresnel surface of the photographing lens system in the third embodiment.

FIG. 15 is a cross-sectional view illustrating a third Fresnel surface of the photographing lens system in the third embodiment.

FIG. 16 is a graph showing spherical aberration induced in the photographing lens system in the third embodiment.

FIG. 17 is a graph showing astigmatism induced in the photographing lens system in the third embodiment.

FIG. 18 is a diagram illustrating another exemplary photographing lens system incorporated in a fourth embodiment of the infrared camera apparatus according to the present invention.

FIG. 19 is a cross-sectional view illustrating a first Fresnel surface of the photographing lens system in the fourth embodiment.

FIG. 20 is a cross-sectional view illustrating a second Fresnel surface of the photographing lens system in the fourth embodiment.

FIG. 21 is a cross-sectional view illustrating a fourth Fresnel surface of the photographing lens system in the fourth embodiment.

FIG. 22 is a cross-sectional view illustrating a fifth Fresnel surface of the photographing lens system in the fourth embodiment.

FIG. 23 is a graph showing spherical aberration induced in the photographing lens system in the fourth embodiment.

FIG. 24 is a graph showing astigmatism induced in the photographing lens system in the fourth embodiment.

FIG. 25 is a diagram illustrating another exemplary photographing lens system incorporated in a fifth embodiment of the infrared camera apparatus according to the present invention.

FIG. 26 is a cross-sectional view illustrating a sixth Fresnel surface of the photographing lens system in the fifth embodiment.

FIG. 27 is a cross-sectional view illustrating a seventh Fresnel surface of the photographing lens system in the fifth embodiment.

FIG. 28 is a graph showing spherical aberration induced in the photographing lens system in the fifth embodiment.

FIG. 29 is a graph showing astigmatism induced in the photographing lens system in the fifth embodiment.

FIG. 30 is a diagram illustrating another exemplary photographing lens system incorporated in a sixth embodiment of the infrared camera apparatus according to the present invention.

FIG. 31 is a cross-sectional view illustrating a first Fresnel surface of the photographing lens system in the sixth embodiment.

FIG. 32 is a cross-sectional view illustrating a second Fresnel surface of the photographing lens system in the sixth embodiment.

FIG. 33 is a graph showing spherical aberration induced in the photographing lens system in the sixth embodiment.

FIG. 34 is a graph showing astigmatism induced in the photographing lens system in the sixth embodiment.

FIG. 35 is a diagram illustrating another exemplary photographing lens system incorporated in a seventh embodiment of the infrared camera apparatus according to the present invention.

FIG. 36 is a cross-sectional view illustrating a fifth Fresnel surface of the photographing lens system in the seventh embodiment.

FIG. 37 is a graph showing spherical aberration induced in the photographing lens system in the seventh embodiment.

FIG. 38 is a graph showing astigmatism induced in the photographing lens system in the seventh embodiment.

FIG. 39 is a diagram illustrating another exemplary photographing lens system incorporated in an eighth embodiment of the infrared camera apparatus according to the present invention.

FIG. 40 is a cross-sectional view illustrating a fifth Fresnel surface of the photographing lens system in the eighth embodiment.

FIG. 41 is a graph showing spherical aberration induced in the photographing lens system in the eighth embodiment.

FIG. 42 is a graph showing astigmatism induced in the photographing lens system in the eighth embodiment.

FIG. 43 is a diagram illustrating another exemplary photographing lens system incorporated in a ninth embodiment of the infrared camera apparatus according to the present invention.

FIG. 44 is a cross-sectional view illustrating a first Fresnel surface of the photographing lens system in the ninth embodiment.

FIG. 45 is a cross-sectional view illustrating a second Fresnel surface of the photographing lens system in the ninth embodiment.

FIG. 46 is a graph showing spherical aberration induced in the photographing lens system in the ninth embodiment.

FIG. 47 is a graph showing astigmatism induced in the photographing lens system in the ninth embodiment.

FIG. 48 is a diagram illustrating another exemplary photographing lens system incorporated in a tenth embodiment of the infrared camera apparatus according to the present invention.

FIG. 49 is a cross-sectional view illustrating a first Fresnel surface of the photographing lens system in the tenth embodiment.

FIG. 50 is a cross-sectional view illustrating a second Fresnel surface of the photographing lens system in the tenth embodiment.

FIG. 51 is a graph showing spherical aberration induced in the photographing lens system in the tenth embodiment.

FIG. 52 is a graph showing astigmatism induced in the photographing lens system in the tenth embodiment.

FIG. 53 is a diagram illustrating another exemplary photographing lens system incorporated in an eleventh embodiment of the infrared camera apparatus according to the present invention.

FIG. 54 is a cross-sectional view illustrating a fifth Fresnel surface of the photographing lens system in the eleventh embodiment.

FIG. 55 is a cross-sectional view illustrating a sixth Fresnel surface of the photographing lens system in the eleventh embodiment.

FIG. 56 is a cross-sectional view illustrating a seventh Fresnel surface of the photographing lens system in the eleventh embodiment.

FIG. 57 is a graph showing spherical aberration induced in the photographing lens system in the eleventh embodiment.

FIG. 58 is a graph showing astigmatism induced in the photographing lens system in the eleventh embodiment.

FIG. 59 is a diagram illustrating another exemplary photographing lens system incorporated in a twelfth embodiment of the infrared camera apparatus according to the present invention.

FIG. 60 is a cross-sectional view illustrating a sixth Fresnel surface of the photographing lens system in the twelfth embodiment.

FIG. 61 is a cross-sectional view illustrating a seventh Fresnel surface of the photographing lens system in the twelfth embodiment.

FIG. 62 is a graph showing spherical aberration induced in the photographing lens system in the twelfth embodiment.

FIG. 63 is a graph showing astigmatism induced in the photographing lens system in the twelfth embodiment.

FIG. 64 is a diagram illustrating another exemplary photographing lens system incorporated in a thirteenth embodiment of the infrared camera apparatus according to the present invention that is in a wide-angle photographing posture and a telephotographing posture.

FIG. 65 is a cross-sectional view illustrating a first Fresnel surface of the photographing lens system in the thirteenth embodiment.

FIG. 66 is a cross-sectional view illustrating a third Fresnel surface of the photographing lens system in the thirteenth embodiment.

FIG. 67 is a cross-sectional view illustrating a fourth Fresnel surface of the photographing lens system in the thirteenth embodiment.

FIG. 68 is a graph showing spherical aberration induced in the photographing lens system in the thirteenth embodiment.

FIG. 69 is a graph showing astigmatism induced in the photographing lens system in the thirteenth embodiment.

FIG. 70 is a graph showing spherical aberration induced in the photographing lens system in the thirteenth embodiment when the lens system without a diffraction grating is in focus at wide-angle end.

FIG. 71 is a graph showing spherical aberration induced in the photographing lens system in the thirteenth embodiment.

FIG. 72 is a graph showing astigmatism induced in the photographing lens system in the thirteenth embodiment.

FIG. 73 is a graph showing spherical aberration induced in the photographing lens system in the thirteenth embodiment when the lens system without a diffraction grating is in focus at telephoto end.

FIG. 74 is a diagram illustrating another exemplary photographing lens system incorporated in a fourteenth embodiment of the infrared camera apparatus according to the present invention that is in a wide-angle photographing posture and a telephotographing posture.

FIG. 75 is a cross-sectional view illustrating a sixth Fresnel surface of the photographing lens system in the fourteenth embodiment.

FIG. 76 is a cross-sectional view illustrating a seventh Fresnel surface of the photographing lens system in the fourteenth embodiment.

FIG. 77 is a cross-sectional view illustrating an eighth Fresnel surface of the photographing lens system in the fourteenth embodiment.

FIG. 78 is a graph showing spherical aberration induced in the photographing lens system in the fourteenth embodiment in a wide-angle photographing posture.

FIG. 79 is a graph showing astigmatism induced in the photographing lens system in the fourteenth embodiment in a wide-angle photographing posture.

FIG. 80 is a graph showing spherical aberration induced in the photographing lens system in the fourteenth embodiment in a telephotographing posture.

FIG. 81 is a graph showing astigmatism induced in the photographing lens system in the fourteenth embodiment in a telephotographing posture.

FIG. 82 depicts an example of the Fresnel surfaces in accordance with the present invention.

### BEST MODE OF THE INVENTION

### Embodiment 1

Optical performance of a photographing lens system 100 incorporated in a first embodiment of an infrared camera apparatus is shown in Table 1. In Table 1, f is a focal length (in millimeters), F is an F-number, 2ω is an angle of field (in degrees), and λ₀ is a reference design wavelength (in nanometers).

TABLE 1

| | |
|---|---|
| f | 100.0 |
| F | 5.4 |
| 2ω | 25.0 |
| λ₀ | 10000 |

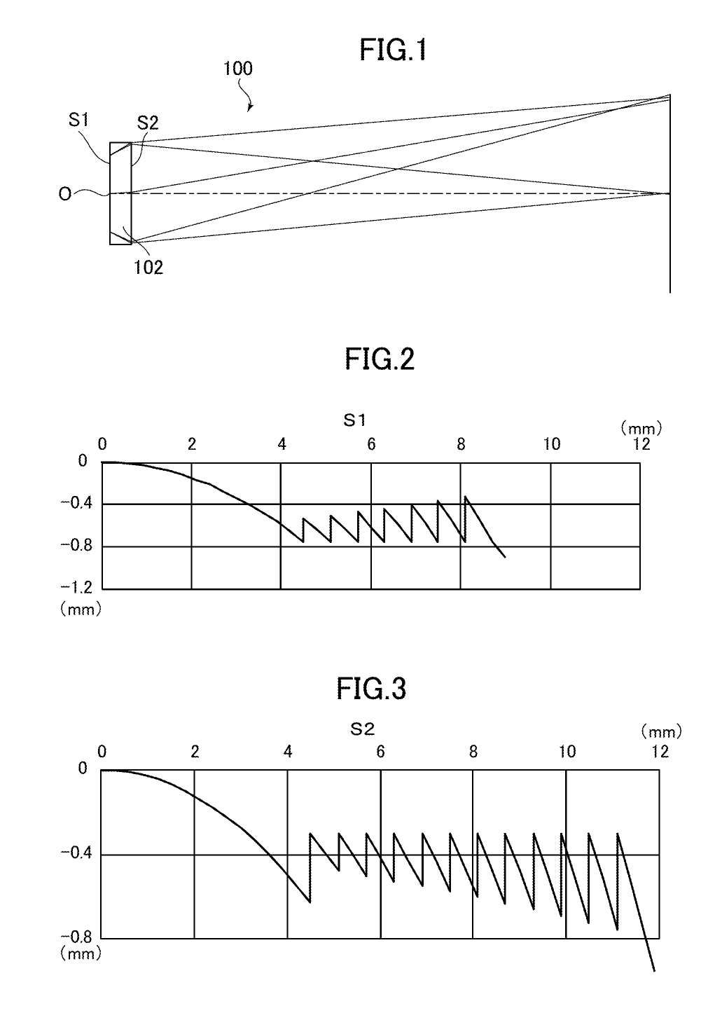

As can be seen in FIG. 1, a photographing lens system 100 incorporated in the first embodiment of the infrared camera apparatus includes a Fresnel lens 102. The Fresnel lens 102 has a surface S1 on one side closer to an object to photograph and a surface S2 on the other side closer to the image plane. A substance of which the Fresnel lens 102 is made is silicone.

Both the surfaces S1 and S2 are aspherical Fresnel surfaces. The surfaces S1 and S2 are respectively shaped in a Fresnel surface divided concentrically into annular curved facets of almost the same radial width. In both of the surfaces S1 and S2, the annular Fresnel lens facets within the centered zone covering 75% of the effective apertuer of the Fresnel lens are greater in average radial width than those in the remaining zone surrounding the centered zone.

The surfaces S1 and S2 are respectively aspherical as expressed by the following mathematical statement (I). Assuming that directions along the optical axis are defined as X-directions while directions orthogonal to the optical axis are defined as Y-directions, H is a height from the optical axis, and X is a distance along the optical axis from a lens apex O intersecting with the optical axis. The X-directions includes a positive direction leading to the image plane.

$$X = \frac{{H}^{2} / R}{1 + \sqrt{1 - ( 1 + K ) {H}^{2} / {R}^{2}}} + {AH}^{2} + {BH}^{4} + {CH}^{6} + {DH}^{8} + {EH}^{10} \qquad ( I )$$

where R is a paraxial radius of curvature, K is a conic constant, and A to E are aspheric coefficients.

Data of optical parameters of the photographing lens system 100 incorporated in the first embodiment of the infrared camera apparatus are provided in Table 2.

TABLE 2

| Surface | | Radius of | Distance btw. |
|---|---|---|---|
| Num. | | Curvature (mm) | Surfaces (mm) |
| S1 | 1st Surface of 1st Lens | −13.503 | 5.000 |
| S2 | 2nd Surface of 1st Lens | −16.139 | |

Data of aspherical surface parameters of the Fresnel surfaces S1 and S2 are provided in Table 3.

TABLE 3

| Surface | | | | | | |
|---|---|---|---|---|---|---|
| Num. | K | A | B | C | D | E |
| S1 | 0.000E+00 | 0.000E+00 | 6.636E−05 | −8.902E−07 | 5.951E−09 | 0.000E+00 |
| S2 | 0.000E+00 | 0.000E+00 | 3.391E−05 | −1.994E−07 | 1.079E−09 | 0.000E+00 |

Cross sectional views of the Fresnel surfaces S1 and S2 are depicted in FIGS. 2 and 3, respectively. In FIGS. 2 and 3, the horizontal axis shows a distance (in millimeters) from the optical axis while the vertical axis shows a lens height (or depth) of the lens relative to the reference point O of the apex of its surface.

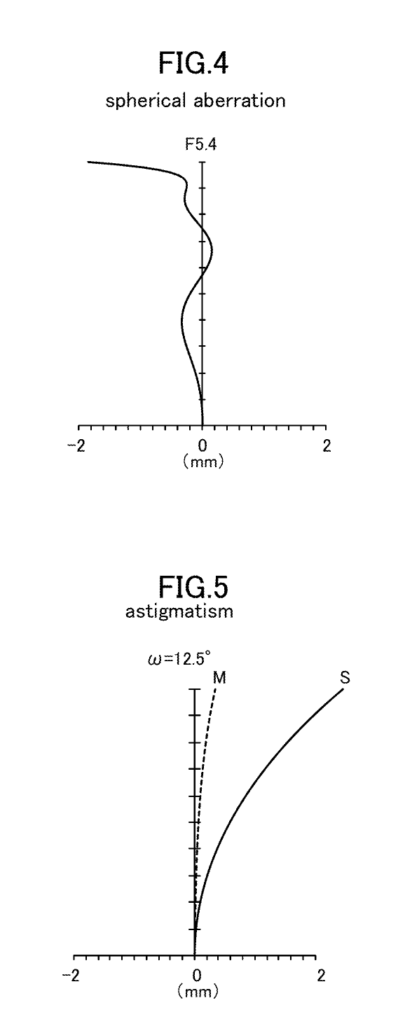

A graph of spherical aberration induced in the photographing lens system 100 incorporated in the first embodiment of the infrared camera apparatus is shown in FIG. 4, and FIG. 5 provides a graph of astigmatism induced therein. In the graph of FIG. 5, solid line denotes the astigmatism observed in a sagittal plane, and broken line denotes that observed in a meridional plane.

### Embodiment 2

Optical performance of a photographing lens system 200 incorporated in a second embodiment of the infrared camera apparatus is provided in Table 4 corresponding to Table 1.

TABLE 4

| | |
|---|---|
| f | 100.0 |
| F | 2.0 |
| 2ω | 50.0 |
| λ₀ | 10000 |

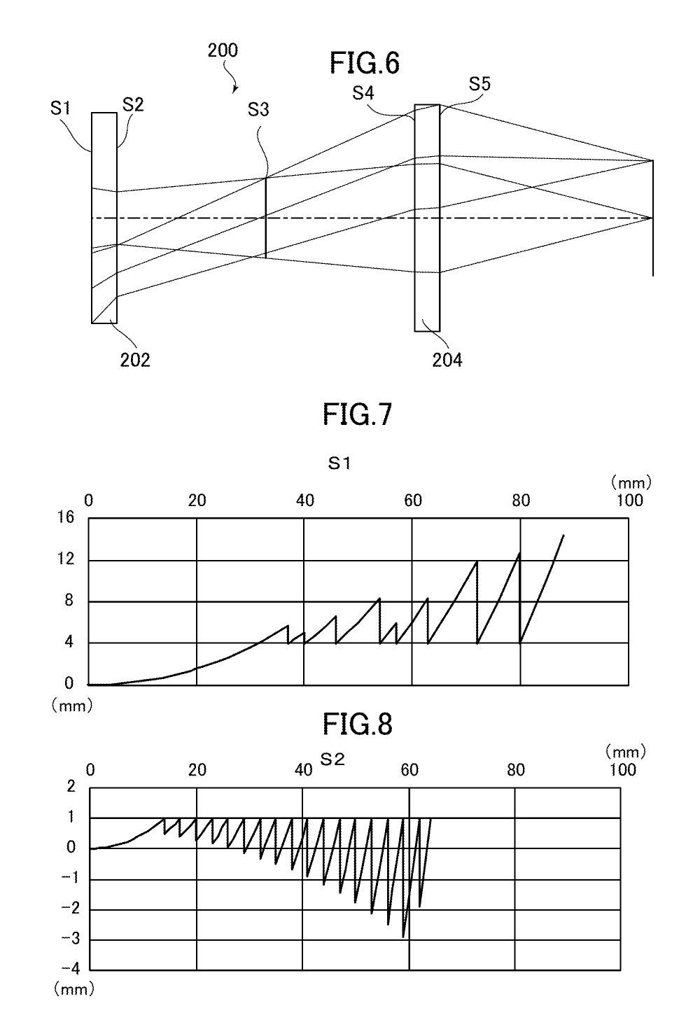

As can be seen in FIG. 6, the photographing lens system 200 incorporated in the second embodiment of the infrared camera apparatus includes a Fresnel lens 202 of negative refractivity having its opposite sides formed in Fresnel surfaces S1 and S2, and another Fresnel lens 204 of positive refractivity having its opposite sides formed in Fresnel surfaces S4 and S5. A substance of which the Fresnel lenses 202 and 204 are made is germanium.

The Fresnel surfaces S1, S2, S4 and S5 are all aspherical Fresnel surfaces. The Fresnel surface S1 is a surface divided concentrically into angular Fresnel lens facets of uneven radial widths. Each of the Fresnel surfaces S2, S4 and S5 is provided with the annular Fresnel lens facets among which those within the centered zone covering 75% of the effective aperture of the Fresnel lens are greater in the radial average width than the remaining annular Fresnel lens facets in the surrounding zone.

Data of optical parameters of the photographing lens system 200 in the second embodiment of the infrared camera apparatus are provided in Table 5.

TABLE 5

| Surface | | Radius of | Distance btw. |
|---|---|---|---|
| Num | | Curvature (mm) | Surfaces (mm) |
| S1 | 1st Surface of 1st Lens | 134.894 | 20.425 |
| S2 | 2nd Surface of 1st Lens | 103.600 | 121.355 |
| S3 | Aperture Stop | Inf. | 121.323 |
| S4 | 1st Surface of 2nd Lens | Inf. | 20.425 |
| S5 | 2nd Surface of 2nd Lens | −388.500 | |

Data of aspherical surface parameters of the Fresnel surfaces S1, S2, S4 and S5 are provided in Table 6.

TABLE 6

| Surface | | | | | | |
|---|---|---|---|---|---|---|
| Num. | K | A | B | C | D | E |
| S1 | 0.000E+00 | 0.000E+00 | 3.133E−07 | −1.040E−11 | 1.178E−16 | 0.000E+00 |
| S2 | 0.000E+00 | 0.000E+00 | 5.521E−07 | 2.852E−11 | −2.108E−15 | 0.000E+00 |
| S4 | 0.000E+00 | 0.000E+00 | 2.309E−08 | −9.707E−12 | 2.384E−16 | 0.000E+00 |
| S5 | 0.000E+00 | 0.000E+00 | 2.934E−08 | −8.986E−12 | 2.638E−16 | 0.000E+00 |

Cross sectional views of the Fresnel surfaces S1, S2, S4 and S5 are depicted in FIGS. 7 to 10, respectively.

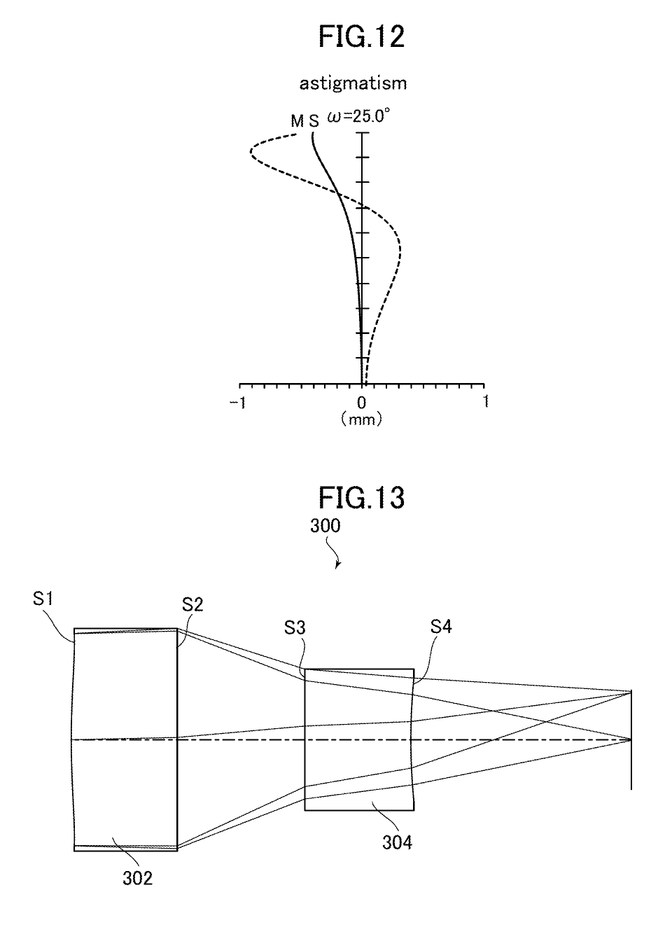

A graph of spherical aberration induced in the photographing lens system 200 in the second embodiment of the infrared camera apparatus is shown in FIG. 11, and FIG. 12 provides a graph of astigmatism induced therein.

### Embodiment 3

Optical performance of a photographing lens system 300 incorporated in a third embodiment of the infrared camera apparatus is provided in Table 7 corresponding to Table 1.

TABLE 7

| | |
|---|---|
| f | 100.0 |
| F | 2.5 |
| 2ω | 10 |
| λ₀ | 10000 |

The photographing lens system 300 in the third embodiment of the infrared camera apparatus includes, as shown in FIG. 13, a Fresnel lens 302 of positive refractivity having its opposite sides formed in an aspherical surface S1 and a Fresnel surface S2, respectively, and another Fresnel lens 304 of negative refractivity having its opposite sides formed in a Fresnel surface S3 and a spherical surface S4, respectively. A substance of which the Fresnel lens 302 is made is germanium while a substance of which the Fresnel lens 304 is made is zinc sulfide.

The Fresnel surfaces S2 and S3 are aspherical Fresnel surfaces. Each of the Fresnel surfaces S2 and S3 are provided with concentric annular Fresnel lens facets among which those within the centered zone covering 75% of the effective aperture of the Fresnel lens are greater in the radial average width than the remaining annular Fresnel lens facets in the surrounding zone.

Data of optical parameters of the photographing lens system 300 in the third embodiment of the infrared camera apparatus are provided in Table 8.

TABLE 8

| Surface | | Radius of | Distance btw. |
|---|---|---|---|
| Num | | Curvature (mm) | Surfaces (mm) |
| S1 | 1st Surface of 1st Lens | 161.733 | 20.000 |
| S2 | 2nd Surface of 1st Lens | 766.863 | 24.097 |
| S3 | 1st Surface of 2nd Lens | −803.776 | 20.000 |
| S4 | 2nd Surface of 2nd Lens | 118.644 | |

Data of aspherical surface parameters of the Fresnel surfaces S1, S2, S3 and S5 are provided in Table 9.

TABLE 9

| Surface | | | | | | |
|---|---|---|---|---|---|---|
| Num. | K | A | B | C | D | E |
| S1 | 0.000E+00 | 0.000E+00 | −3.075E−06 | −1.916E−09 | −2.343E−12 | 0.000E+00 |
| S2 | 0.000E+00 | 0.000E+00 | −4.740E−06 | −1.683E−09 | 1.781E−12 | 0.000E+00 |
| S3 | 0.000E+00 | 0.000E+00 | −6.595E−06 | −1.447E−08 | 2.358E−11 | 0.000E+00 |

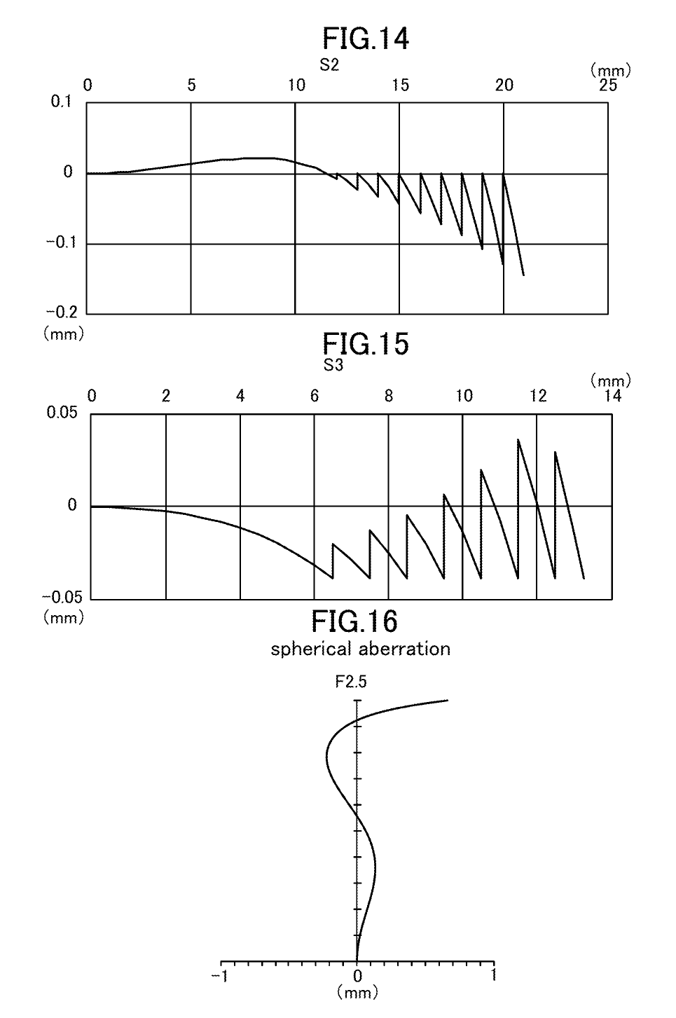

Cross sectional views of the Fresnel surfaces S2 and S3 are depicted in FIGS. 14 and 15, respectively.

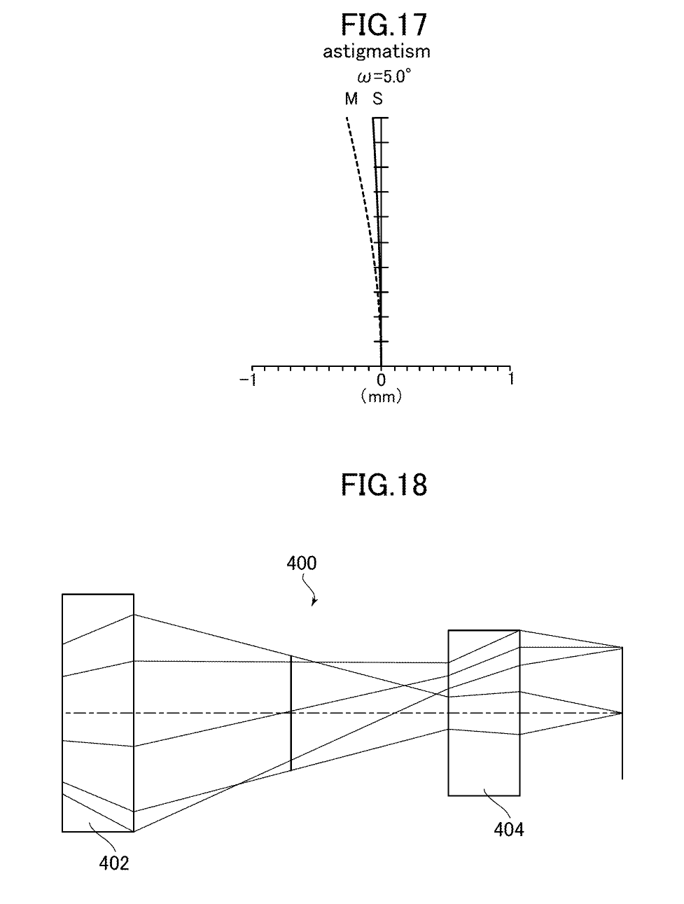

A graph of spherical aberration induced in the photographing lens system 300 in the third embodiment of the infrared camera apparatus is shown in FIG. 16, and FIG. 17 provides a graph of astigmatism induced therein.

### Embodiment 4

Optical performance of a photographing lens system 400 incorporated in a fourth embodiment of the infrared camera apparatus is provided in Table 10 corresponding to Table 1.

TABLE 10

| | |
|---|---|
| f | 100.0 |
| F | 2.5 |
| 2ω | 38.9 |
| λ₀ | 10000 |

The photographing lens system 400 in the fourth embodiment of the infrared camera apparatus includes, as shown in FIG. 18, a Fresnel lens 402 of positive refractivity having its opposite sides respectively formed in Fresnel aspherical surfaces S1 and S2, and another Fresnel lens 404 of positive refractivity having its opposite sides respectively formed in Fresnel aspherical surfaces S4 and S5. A substance of which the Fresnel lenses 402 and 404 are made is germanium.

Each of the Fresnel surfaces S1, S2, S3 and S4 is provided with annular Fresnel lens facets among which those within the centered zone covering 75% of the effective apertuer of the Fresnel lens are greater in the radial average width than the remaining annular Fresnel lens facets in the surrounding region.

Data of the optical parameters of the photographing lens system 400 in the fourth embodiment of the infrared camera apparatus are provided in Table 11.

TABLE 11

| Surface | | Radius of | Distance btw. |
|---|---|---|---|
| Num. | | Curvature (mm) | Surfaces (mm) |
| S1 | 1st Surface of 1st Lens | −48.052 | 20.000 |
| S2 | 2nd Surface of 1st Lens | −52.596 | 44.016 |
| S3 | Aperture Stop | Inf. | 44.016 |
| S4 | 1st Surface of 2nd Lens | −24.729 | 20.000 |
| S5 | 2nd Surface of 2nd Lens | −35.989 | |

Data of aspherical surface parameters of the Fresnel surfaces S1, S2, S4 and S5 are provided in Table 12.

TABLE 12

| Surface | | | | | | |
|---|---|---|---|---|---|---|
| Num. | K | A | B | C | D | E |
| S1 | 0.000E+00 | 0.000E+00 | −2.726E−06 | −3.049E−09 | −1.864E−12 | 0.000E+00 |
| S2 | 0.000E+00 | 0.000E+00 | −4.189E−07 | −3.380E−10 | 2.298E−13 | 0.000E+00 |
| S4 | 0.000E+00 | 0.000E+00 | 3.966E−06 | −3.910E−08 | 1.714E−10 | 0.000E+00 |
| S5 | 0.000E+00 | 0.000E+00 | 2.050E−06 | −2.226E−09 | 5.027E−12 | 0.000E+00 |

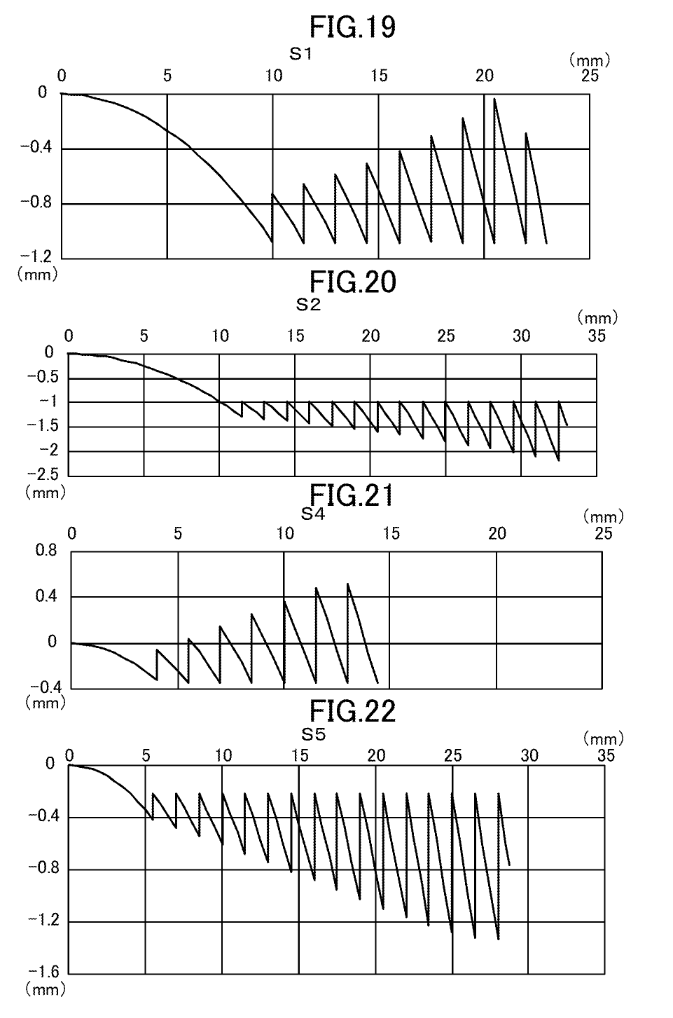

Cross sectional views of the Fresnel surfaces S1, S2, S4 and S5 are depicted in FIGS. 19 to 22, respectively.

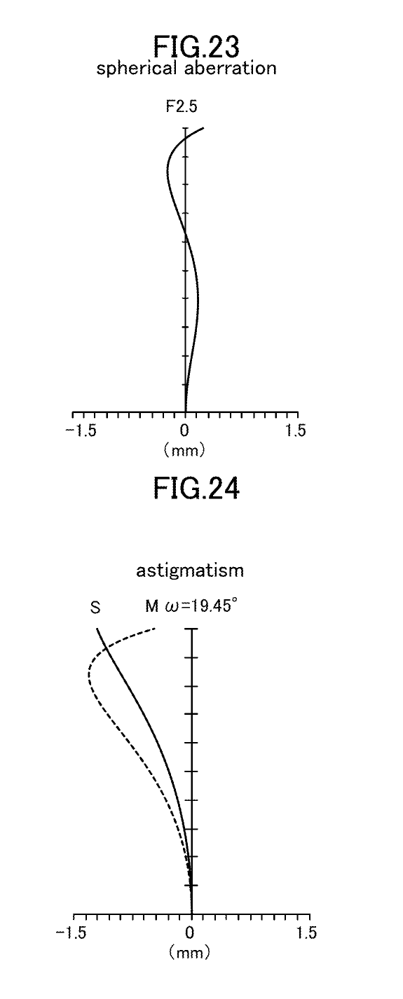

A graph of spherical aberration induced in the photographing lens system 400 in the fourth embodiment of the infrared camera apparatus is shown in FIG. 23, and FIG. 24 provides a graph of astigmatism induced therein.

### Embodiment 5

Optical performance of a photographing lens system 500 in a fifth embodiment of the infrared camera apparatus is provided in Table 13 corresponding to Table 1.

TABLE 13

| | |
|---|---|
| f | 100.0 |
| F | 1.4 |
| 2ω | 12.3 |
| λ₀ | 10000 |

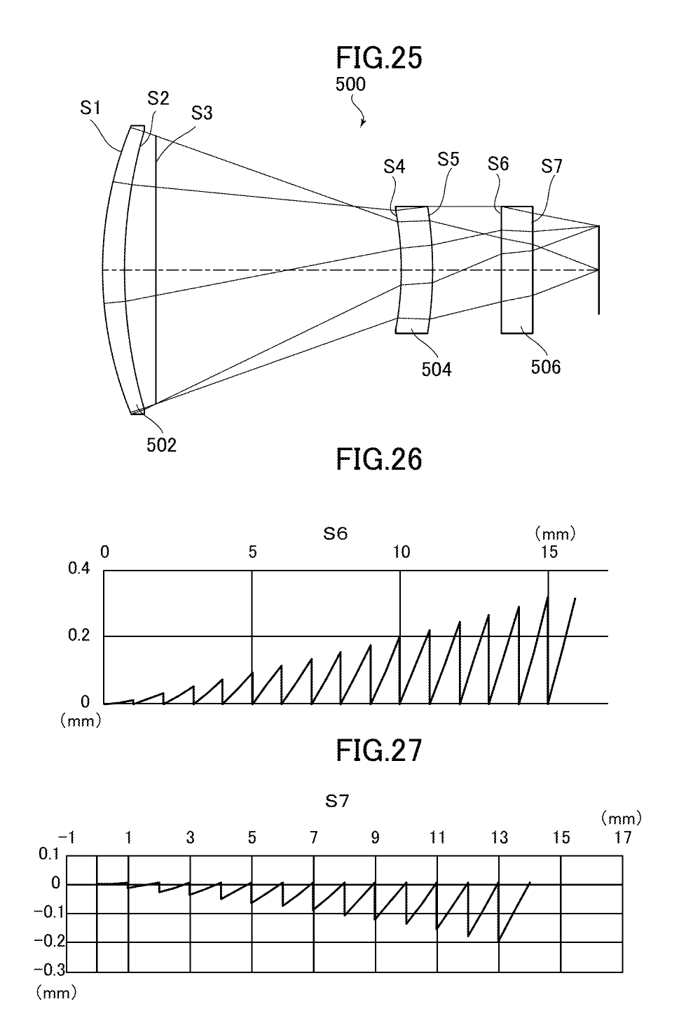

The photographing lens system 500 in the fifth embodiment of the infrared camera apparatus includes, as shown in FIG. 25, a spherical lens 502 of positive refractivity having its opposite sides respectively formed in spherical surfaces S1 and S2, a spherical lens 504 of negative refractivity having its opposite sides respectively formed in spherical surfaces S3 and S4, and an aspherical lens 506 of positive refractivity having its opposite sides respectively formed in Fresnel aspherical surfaces S6 and S7. A substance of which the spherical lenses 502 and 504 are made is germanium. The Fresnel aspherical lens 506 is made of a substance of chalcogenide.

Each of the Fresnel aspherical surfaces S6 and S7 is provided with concentric annular Fresnel lens facets of almost the same radial width.

Data of optical parameters of the photographing lens system 500 in the fifth embodiment of the infrared camera apparatus are provided in Table 14.

TABLE 14

| Surface | | Radius of | Distance btw. |
|---|---|---|---|
| Num | | Curvature (mm) | Surfaces (mm) |
| S1 | 1st Surface of 1st Lens | 93.211 | 5.600 |
| S2 | 2nd Surface of 1st Lens | 123.364 | 8.000 |
| S3 | Aperture Stop | Inf. | 62.700 |
| S4 | 1st Surface of 2nd Lens | −78.927 | 8.000 |
| S5 | 2nd Surface of 2nd Lens | −100.313 | 17.578 |
| S6 | 1st Surface of 3rd Lens | 49.145 | 8.000 |
| S7 | 2nd Surface of 3rd Lens | 84.711 | |

Data of aspherical surface parameters of the Fresnel aspherical surfaces S6 and S7 are provided in Table 15.

TABLE 15

| Surface | | | | | | |
|---|---|---|---|---|---|---|
| Num. | K | A | B | C | D | E |
| S1 | 0.000E+00 | 0.000E+00 | 1.246E−07 | 1.075E−09 | 2.031E−12 | 0.000E+00 |
| S7 | 0.000E+00 | 0.000E+00 | 4.295E−06 | −7.142E−09 | 2.894E−11 | 0.000E+00 |

Cross sectional views of the Fresnel aspherical surfaces S6 and S7 are depicted in FIGS. 26 and 27, respectively.

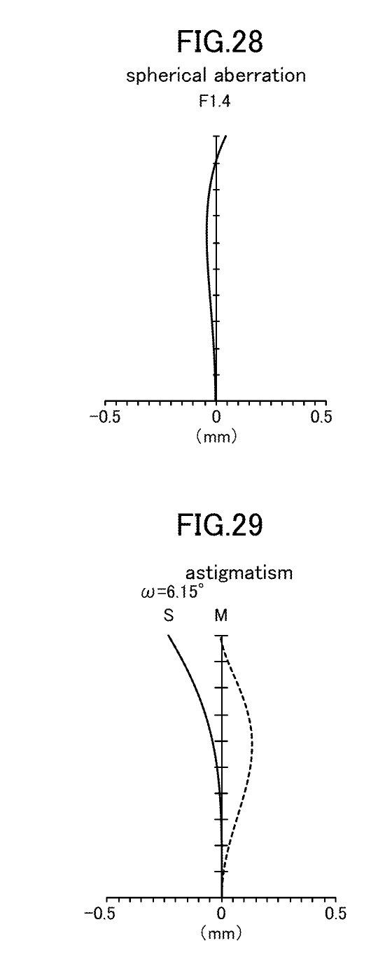

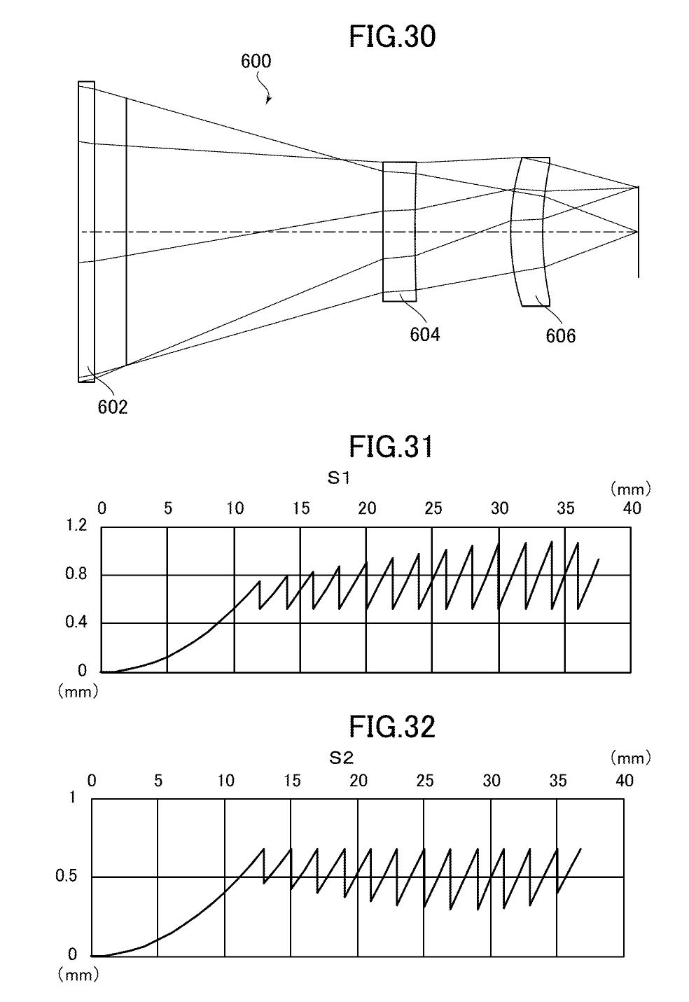

A graph of spherical aberration induced in the photographing lens system 500 in the fifth embodiment of the infrared camera apparatus is shown in FIG. 28, and FIG. 29 provides a graph of astigmatism induced therein.

### Embodiment 6

Optical performance of a photographing lens system 600 incorporated in a sixth embodiment of the infrared camera apparatus is provided in Table 16 corresponding to Table 1.

TABLE 16

| | |
|---|---|
| f | 100.0 |
| F | 1.4 |
| 2ω | 12.6 |
| λ₀ | 10000 |

The photographing lens system 600 in the sixth embodiment of the infrared camera apparatus includes, as shown in FIG. 30, a Fresnel aspherical lens 602 of positive refractivity having its opposite sides respectively formed in Fresnel aspherical surfaces S1 and S2, a spherical lens 604 of negative refractivity having its opposite sides respectively formed in spherical surfaces S3 and S4, and a spherical lens 606 of positive refractivity having its opposite sides respectively formed in spherical surfaces S6 and S7. A substance of which all the lenses 602, 604 and 606 are made is germanium.

Each of the Fresnel aspherical surfaces S1 and S2 is provided with concentric annular Fresnel lens facets among which those within the centered zone covering 75% of the effective apertuer of the Fresnel lens are greater in the radial average width than the remaining annular Fresnel lens facets in the surrounding zone.

Data of optical parameters of the photographing lens system 600 in the sixth embodiment of the infrared camera apparatus are given in Table 17.

TABLE 17

| Surface | | Radius of | Distance btw. |
|---|---|---|---|
| Num | | Curvature (mm) | Surfaces (mm) |
| S1 | 1st Surface of 1st Lens | 95.816 | 4.000 |
| S2 | 2nd Surface of 1st Lens | 122.909 | 8.000 |
| S3 | Aperture Stop | Inf. | 64.208 |
| S4 | 1st Surface of 2nd Lens | Inf. | 8.000 |
| S5 | 2nd Surface of 2nd Lens | 457.700 | 23.939 |
| S6 | 1st Surface of 3rd Lens | 61.483 | 8.000 |
| S7 | 2nd Surface of 3rd Lens | 83.699 | |

Data of aspherical surface parameters of the Fresnel aspherical surfaces S1 and S2 are provided in Table 18.

TABLE 18

| Surface | | | | | | |
|---|---|---|---|---|---|---|
| Num. | K | A | B | C | D | E |
| S1 | 0.000E+00 | 0.000E+00 | −1.975E−07 | −1.405E−10 | −9.794E−14 | 7.878E−18 |
| S7 | 0.000E+00 | 0.000E+00 | −1.331E−07 | −2.281E−10 | −6.170E−14 | 1.599E−18 |

Cross sectional views of the Fresnel aspherical surfaces S1 and S2 are depicted in FIGS. 31 and 32, respectively.

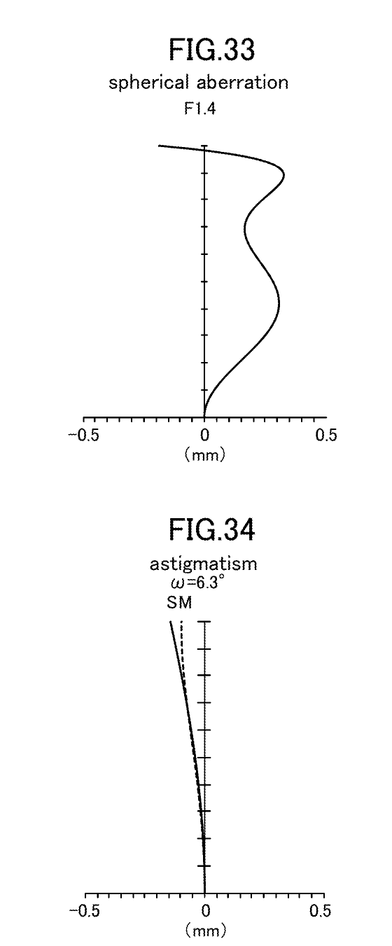

A graph of spherical aberration induced in the photographing lens system 600 in the sixth embodiment of the infrared camera apparatus is shown in FIG. 33, and FIG. 34 provides a graph of astigmatism induced therein.

### Embodiment 7

Optical performance of a photographing lens system 700 incorporated in a seventh embodiment of the infrared camera apparatus is given in Table 19 corresponding to Table 1.

TABLE 19

| | |
|---|---|
| f | 100.0 |
| F | 1.4 |
| 2ω | 12.6 |
| λ₀ | 3000 |

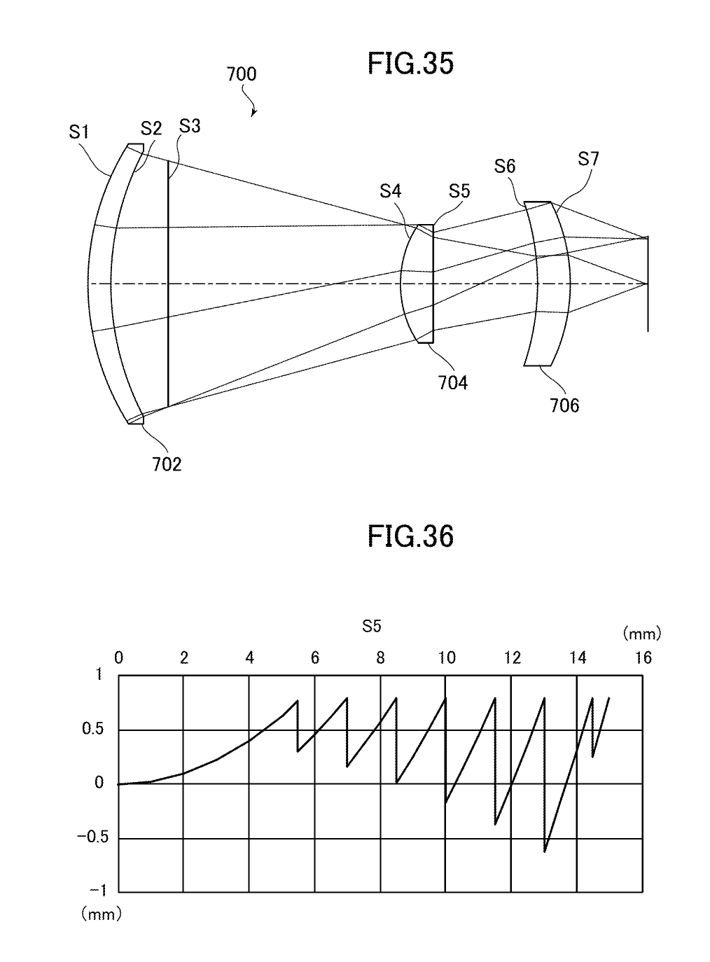

The photographing lens system 700 in the seventh embodiment of the infrared camera apparatus includes, as shown in FIG. 35, a spherical lens 702 of positive refractivity having its opposite sides respectively formed in spherical surfaces S1 and S2, a Fresnel lens 704 of negative refractivity having its opposite sides respectively formed in an aspherical surface S4 and a Fresnel aspherical surface S5, and a spherical lens 706 of positive refractivity having its opposite sides respectively formed in spherical surfaces S6 an S7. The lenses 702, 704, and 706 are all made of a substance of germanium.

The Fresnel aspherical surface S5 is provided with concentric annular Fresnel lens facets among which those within the centered zone covering 75% of the effective apertuer of the Fresnel lens are greater in the radial average width than the remaining annular Fresnel lens facets in the surrounding zone.

Data of optical parameters of the photographing lens system 700 in the seventh embodiment of the infrared camera apparatus are given in Table 20.

TABLE 20

| Surface | | Radius of | Distance btw. |
|---|---|---|---|
| Num | | Curvature (mm) | Surfaces (mm) |
| S1 | 1st Surface of 1st Lens | 63.888 | 5.600 |
| S2 | 2nd Surface of 1st Lens | 69.799 | 14.000 |
| S3 | Aperture Stop | Inf. | 56.700 |
| S4 | 1st Surface of 2nd Lens | 27.061 | 8.000 |
| S5 | 2nd Surface of 2nd Lens | 20.000 | 25.460 |
| S6 | 1st Surface of 3rd Lens | −61.935 | 8.000 |
| S7 | 2nd Surface of 3rd Lens | −44.223 | |

Data of aspherical surface parameters of the Fresnel aspherical surface S5 are provided in Table 21.

TABLE 21

| Surface | | | | | | |
|---|---|---|---|---|---|---|
| Num. | K | A | B | C | D | E |
| S5 | 0.000E+00 | 0.000E+00 | 1.903E−06 | 3.297E−09 | 5.922E−11 | 0.000E+00 |

A cross sectional view of the Fresnel aspherical surface S5 is depicted in FIG. 35.

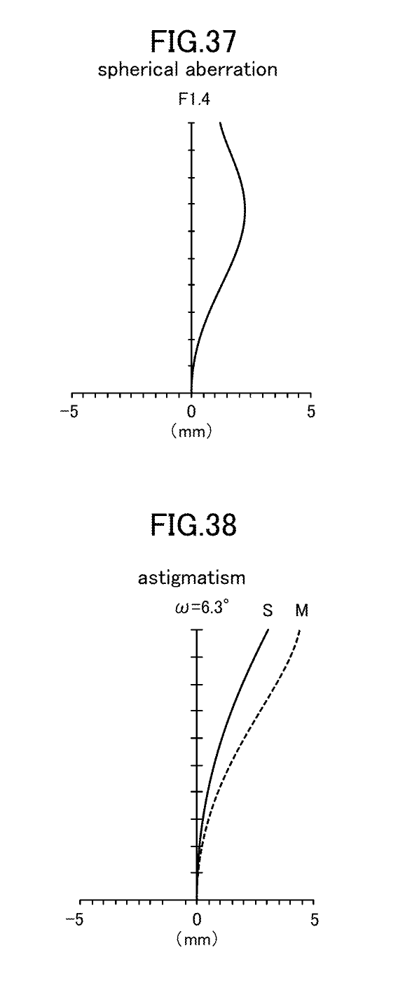

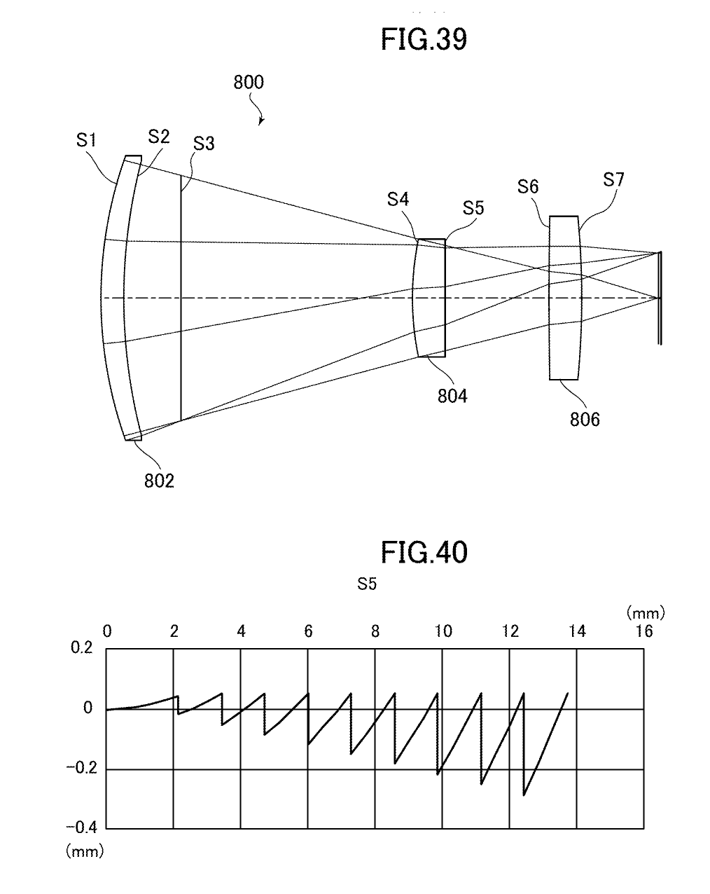

A graph of spherical aberration induced in the photographing lens system 700 in the seventh embodiment of the infrared camera apparatus is shown in FIG. 37, and FIG. 38 provides a graph of astigmatism induced therein.

### Embodiment 8

Optical performance of a photographing lens system 800 incorporated in an eighth embodiment of the infrared camera apparatus is provided in Table 22 corresponding to Table 1.

TABLE 22

| | |
|---|---|
| f | 100.0 |
| F | 1.7 |
| 2ω | 10.8 |
| λ₀ | 3000 |

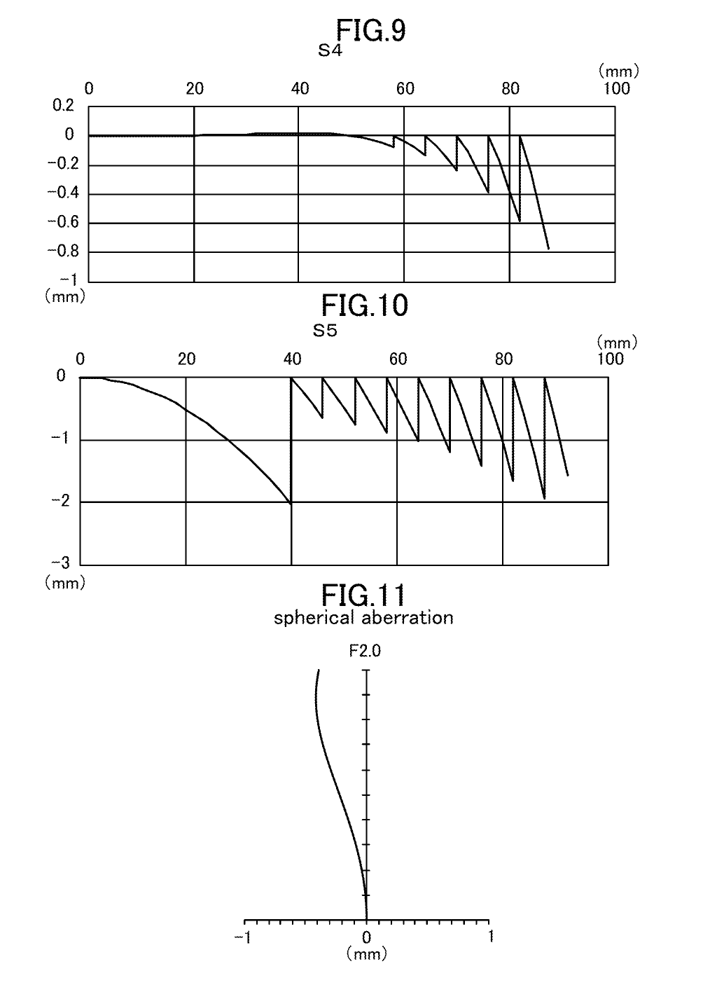

The photographing lens system 800 in the eighth embodiment of the infrared camera apparatus includes, as shown in FIG. 9, a spherical lens 802 of positive refractivity having its opposite sides respectively formed in spherical surfaces S1 and S2, a Fresnel lens 804 of negative refractivity having its opposite sides respectively formed in a spherical surface S4 and a Fresnel spherical surface S5, and a spherical lens 806 of positive refractivity having its opposite sides respectively formed in spherical surfaces S6 and S7. A substance of which the spherical lens 802 is made is germanium. The Fresnel lens 804 is made of a substance of zinc sulfide. The spherical lens 806 is made of another substance of zinc selenide.

The Fresnel surface S5 is provided with concentric annular Fresnel lens facets among which those within the centered zone covering 75% of the effective aperture of the Fresnel lens are greater in the radial average width than the remaining annular Fresnel lens facets in the surrounding zone.

Data of optical parameters of the photographing lens system 800 in the eighth embodiment of the infrared camera apparatus are given in Table 23.

TABLE 23

| Surface | | Radius of | Distance btw. |
|---|---|---|---|
| Num | | Curvature (mm) | Surfaces (mm) |
| S1 | 1st Surface of 1st Lens | 88.604 | 4.807 |
| S2 | 2nd Surface of 1st Lens | 113.988 | 12.017 |
| S3 | Aperture Stop | Inf. | 48.669 |
| S4 | 1st Surface of 2nd Lens | 61.186 | 6.867 |
| S5 | 2nd Surface of 2nd Lens | 51.501 | 21.854 |
| S6 | 1st Surface of 3rd Lens | 988.347 | 6.867 |
| S7 | 2nd Surface of 3rd Lens | −181.191 | |

A cross sectional view of the Fresnel spherical surface S5 is shown in FIG. 40.

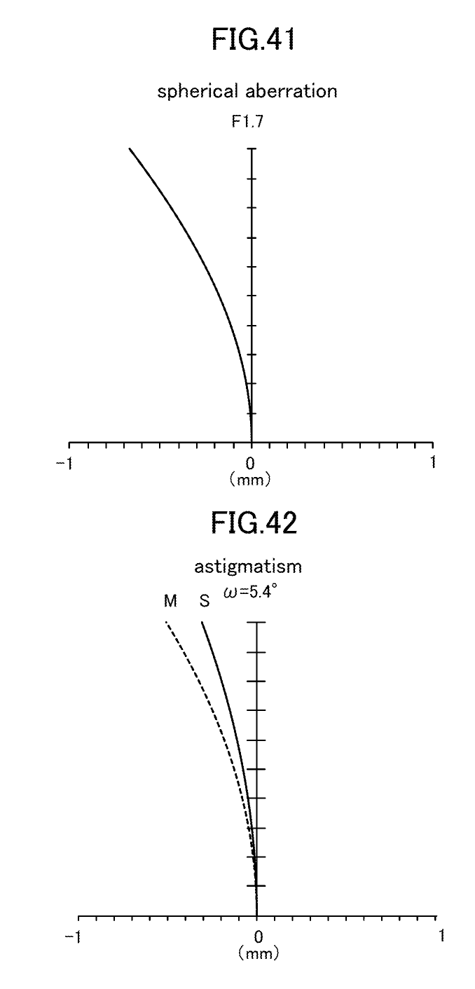

A graph of spherical aberration induced in the photographing lens system 800 in the eighth embodiment of the infrared camera apparatus is depicted in FIG. 41, and FIG. 42 provides a graph of astigmatism induced therein.

### Embodiment 9

Optical performance of a photographing lens system 900 incorporated in a ninth embodiment of the infrared camera apparatus is provided in Table 24 corresponding to Table 1.

TABLE 24

| | |
|---|---|
| f | 100 |
| F | 1.4 |
| 2ω | 12.5 |
| λ₀ | 3000 |

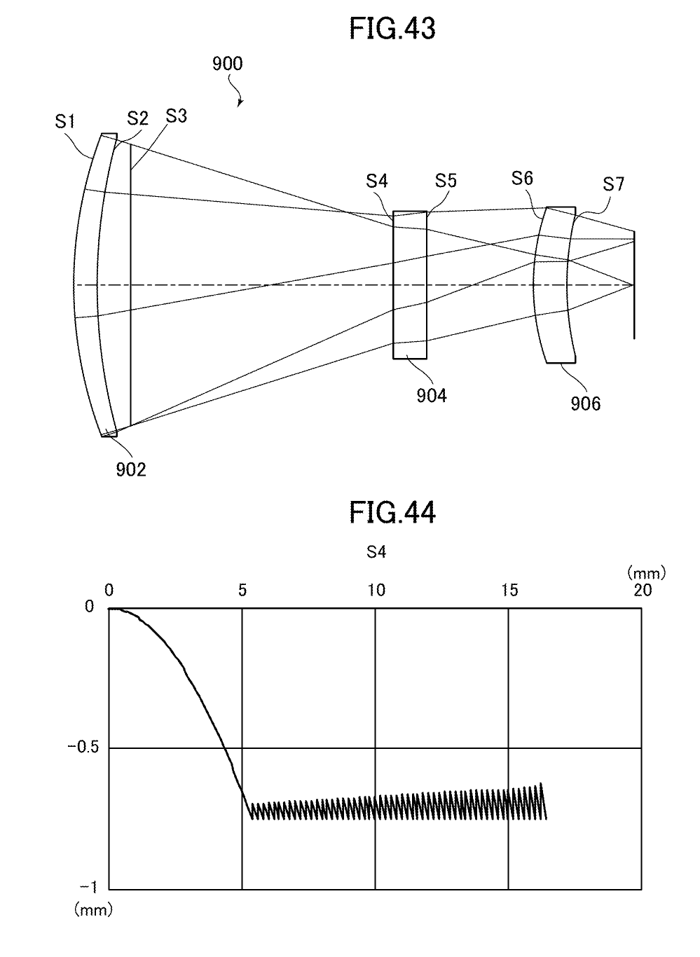

The photographing lens system 900 in the ninth embodiment of the infrared camera apparatus includes, as shown in FIG. 43, a spherical lens 902 of positive refractivity having its opposite sides respectively formed in spherical surfaces S1 and S2, a Fresnel lens 904 of negative refractivity having its opposite sides respectively formed in Fresnel aspherical surfaces S4 and S5, and a spherical lens 906 of positive refractivity having its opposite sides respectively formed in spherical surfaces S6 and S7. A substance of which the spherical lenses 902 and 906 are made is germanium. The Fresnel lens 904 is made of a substance of magnesium fluoride.

Each of the Fresnel aspherical surfaces S4 and S5 is provided with concentric annular Fresnel lens facets among which those within the centered zone covering 75% of the effective apertuer of the Fresnel lens are greater in the radial average width than the remaining annular Fresnel lens facets in the surrounding zone. However, the annular Fresnel lens facets of the Fresnel aspherical surface S4 have their respective radial widths sized to be smaller than those of the Fresnel aspherical surface S5.

Data of optical parameters of the photographing lens system 900 in the ninth embodiment of the infrared camera apparatus are given in Table 25.

TABLE 25

| Surface | | Radius of | Distance btw. |
|---|---|---|---|
| Num | | Curvature (mm) | Surfaces (mm) |
| S1 | 1st Surface of 1st Lens | 101.000 | 5.600 |
| S2 | 2nd Surface of 1st Lens | 133.000 | 8.000 |
| S3 | Aperture Stop | Inf. | 62.700 |
| S4 | 1st Surface of 2nd Lens | −17.849 | 8.000 |
| S5 | 2nd Surface of 2nd Lens | −24.701 | 25.460 |
| S6 | 1st Surface of 3rd Lens | 56.000 | 8.000 |
| S7 | 2nd Surface of 3rd Lens | 71.000 | |

Data of aspherical surface parameters of the Fresnel aspherical surfaces S4 and S5 are provided in Table 26.

TABLE 26

| Surface | | | | | | |
|---|---|---|---|---|---|---|
| Num. | K | A | B | C | D | E |
| S4 | 0.000E+00 | 0.000E+00 | 1.138E−04 | −4.266E−07 | 1.054E−09 | 0.000E+00 |
| S5 | 0.000E+00 | 0.000E+00 | 6.033E−05 | −1.650E−07 | 2.435E−10 | 0.000E+00 |

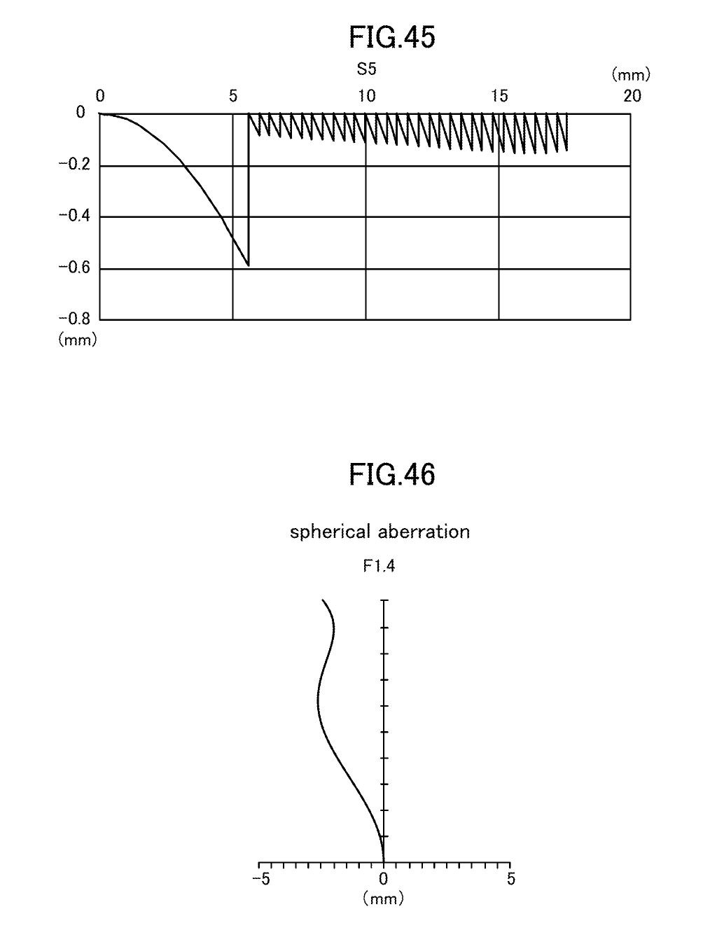

Cross sectional views of the Fresnel aspherical surfaces S4 and S5 are depicted in FIGS. 44 and 45, respectively.

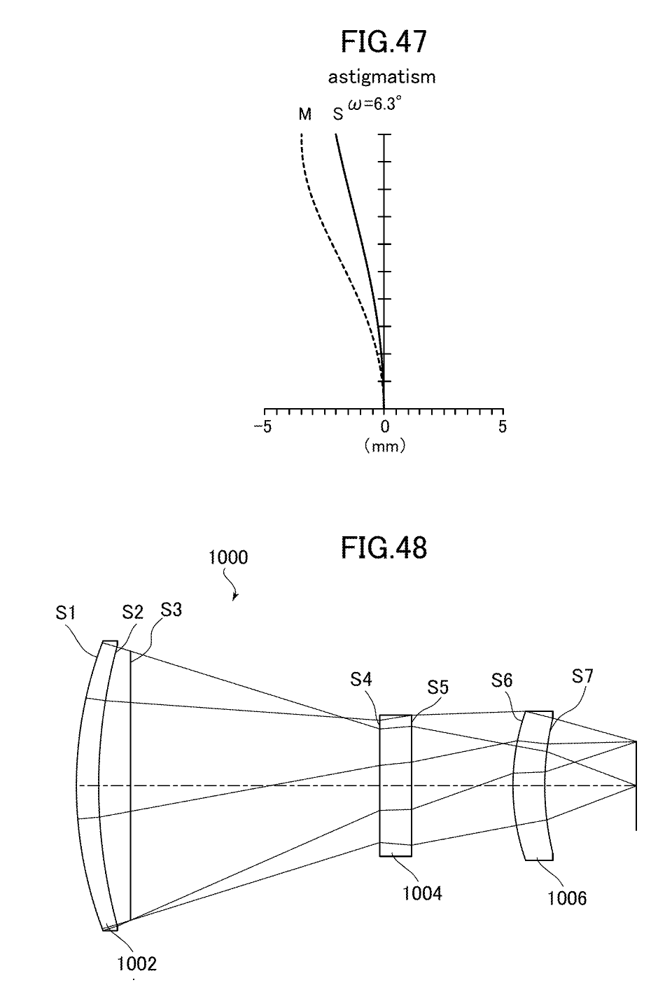

A graph of spherical aberration induced in the photographing lens system 900 in the ninth embodiment of the infrared camera apparatus is shown in FIG. 46, and FIG. 47 provides a graph of astigmatism induced therein.

### Embodiment 10

Optical performance of a photographing lens system 1000 incorporated in a tenth embodiment of the infrared camera apparatus is provided in Table 27 corresponding to Table 1.

TABLE 27

| | |
|---|---|
| f | 100.0 |
| F | 1.4 |
| 2ω | 12.6 |
| λ₀ | 10000 |

The photographing lens system 1000 in the tenth embodiment of the infrared camera apparatus includes, as shown in FIG. 48, a spherical lens 1002 of positive refractivity having its opposite sides respectively formed in spherical surfaces S1 and S2, a Fresnel lens 1004 of negative refractivity having its opposite sides respectively formed in Fresnel aspherical surfaces S4 and S5, and a spherical lens 906 of positive refractivity having its opposite sides respectively formed in spherical surfaces S6 and S7. A substance of which all the lenses 1002, 1004, and 1006 are made is germanium.

The Fresnel aspherical surface S5 is divided concentrically into annular Fresnel lens facets all of which are equivalent in height in the direction in parallel with the optical axis in both a center region and an outer region surrounding the center region. The Fresnel aspherical surface S6 is provided with concentric annular Fresnel lens facets among which those within the centered zone covering 75% of the effective apertuer of the Fresnel lens have greater heights in the direction in parallel with the optical axis than the remaining annular Fresnel lens facets in the surrounding zone.

Data of optical parameters of the photographing lens system 1000 in the tenth embodiment of the infrared camera apparatus is provided in Table 28.

TABLE 28

| Surface | | Radius of | Distance btw. |
|---|---|---|---|
| Num | | Curvature (mm) | Surfaces (mm) |
| S1 | 1st Surface of 1st Lens | 101.000 | 5.600 |
| S2 | 2nd Surface of 1st Lens | 133.000 | 8.000 |
| S3 | Aperture Stop | Inf. | 62.700 |
| S4 | 1st Surface of 2nd Lens | −67.361 | 8.000 |
| S5 | 2nd Surface of 2nd Lens | −84.409 | 25.460 |
| S6 | 1st Surface of 3rd Lens | 56.000 | 8.000 |
| S7 | 2nd Surface of 3rd Lens | 71.000 | |

Data of aspherical surface parameters of the Fresnel aspherical surfaces S4 and S5 are provided in Table 29.

TABLE 29

| Surface | | | | | | |
|---|---|---|---|---|---|---|
| Num. | K | A | B | C | D | E |
| S4 | 0.000E+00 | 0.000E+00 | 1.1861E−06 | −2.7885E−09 | 4.3819E−12 | 0.000E+00 |
| S5 | 0.000E+00 | 0.000E+00 | 8.7661E−07 | −1.8826E−09 | 2.6110E−12 | 0.000E+00 |

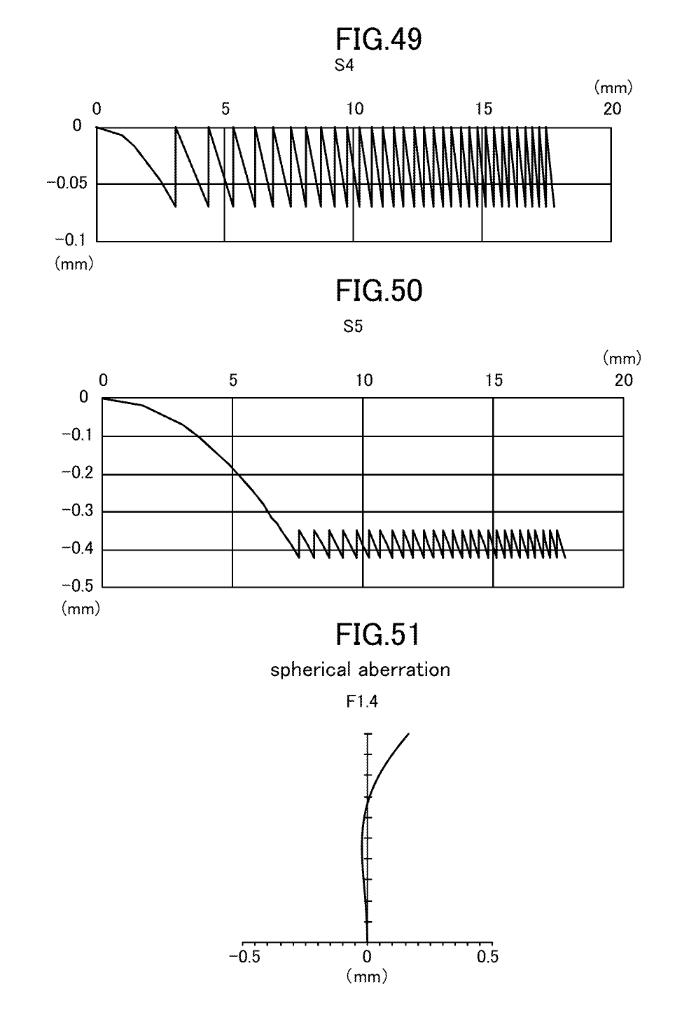

Cross sectional views of the Fresnel aspherical surfaces S5 and S6 are depicted in FIGS. 49 and 50, respectively.

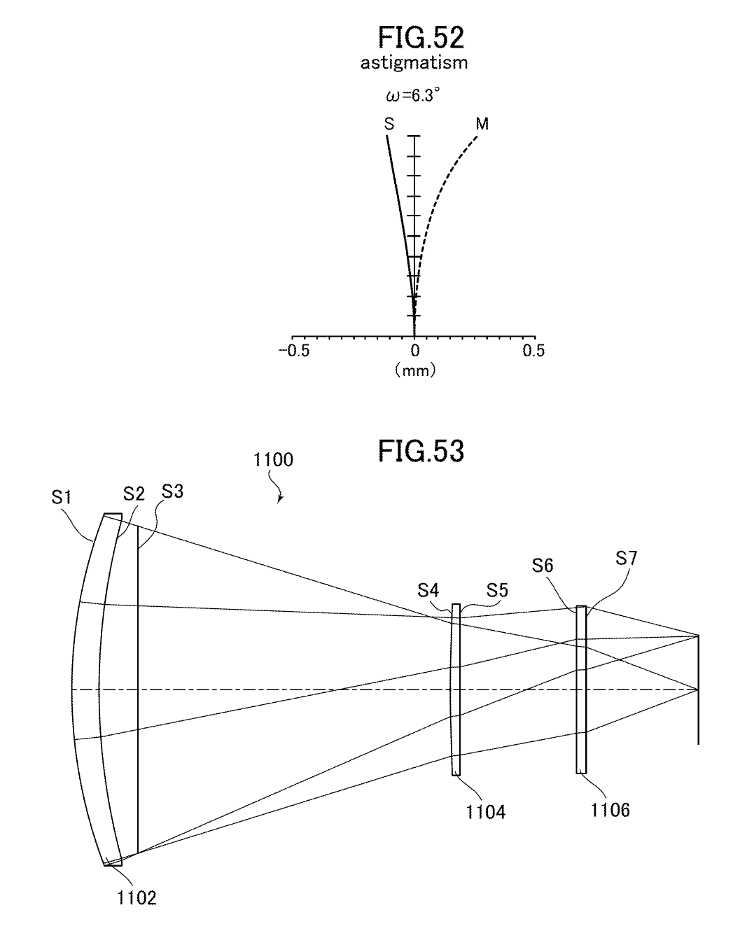

A graph of spherical aberration induced in the photographing lens system 1000 in the tenth embodiment of the infrared camera apparatus is shown in FIG. 51, and FIG. 52 provides a graph of astigmatism induced therein.

### Embodiment 11

Optical performance of a photographing lens system 1100 incorporated in an eleventh embodiment of the infrared camera apparatus is provided in Table 30 corresponding to Table 1.

TABLE 30

| | |
|---|---|
| f | 100.3 |
| F | 1.4 |
| 2ω | 12.5 |
| λ₀ | 10000 |

The photographing lens system 1100 in the eleventh embodiment of the infrared camera apparatus includes, as shown in FIG. 53, a spherical lens 1102 of positive refractivity having its opposite sides respectively formed in spherical surfaces S1 and S2, a Fresnel lens 1104 of negative refractivity having its opposite sides respectively formed in an aspherical surface S4 and a Fresnel aspherical surface S5, and a Fresnel lens 1106 of positive refractivity having its opposites sides respectively formed in Fresnel aspherical surfaces S6 and S7. The lenses 1102, 1104, and 1106 are all made of germanium.

Each of the Fresnel aspherical surfaces S5, S6 and S7 is provided with concentric annular Fresnel lens facets among which those within the centered zone covering 75% of the effective apertuer of the Fresnel lens are greater in the radial average width than the remaining annular Fresnel lens facets in the surrounding zone.

Data of optical parameters of the photographing lens system 1100 in the eleventh embodiment of the infrared camera apparatus is given in Tale 31.

TABLE 31

| Surface | | Radius of | Distance btw. |
|---|---|---|---|
| Num | | Curvature (mm) | Surfaces (mm) |
| S1 | 1st Surface of 1st Lens | 101.000 | 5.600 |
| S2 | 2nd Surface of 1st Lens | 133.000 | 8.000 |
| S3 | Aperture Stop | Inf. | 64.210 |
| S4 | 1st Surface of 2nd Lens | 235.704 | 2.000 |
| S5 | 2nd Surface of 2nd Lens | 148.399 | 23.940 |
| S6 | 1st Surface of 3rd Lens | 103.815 | 2.000 |
| S7 | 2nd Surface of 3rd Lens | 299.614 | |

Data of aspherical surface parameters of the aspherical surface S4 and the Fresnel aspherical surfaces S5, S6 and S7 are provided in Table 32.

TABLE 32

| Surface | | | | | | |
|---|---|---|---|---|---|---|
| Num. | K | A | B | C | D | E |
| S4 | 0.000E+00 | 0.000E+00 | −1.142E−06 | −1.494E−08 | 3.510E−11 | 0.000E+00 |
| S5 | 0.000E+00 | 0.000E+00 | −7.267E−07 | −1.640E−08 | 3.972E−11 | 0.000E+00 |
| S6 | 0.000E+00 | 0.000E+00 | −3.948E−06 | −2.912E−08 | 1.339E−11 | 0.000E+00 |
| S7 | 0.000E+00 | 0.000E+00 | −4.169E−06 | −3.171E−08 | 2.473E−11 | 0.000E+00 |

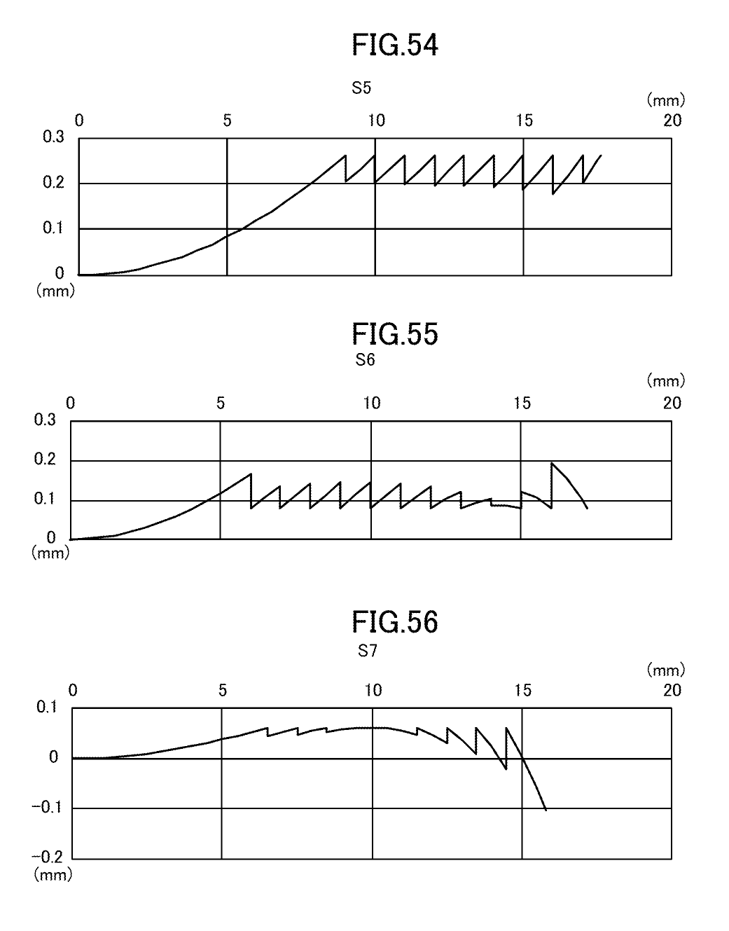

Cross sectional views of the Fresnel aspherical surfaces S5, S6 and S7 are depicted in FIGS. 54, 55 and 56, respectively.

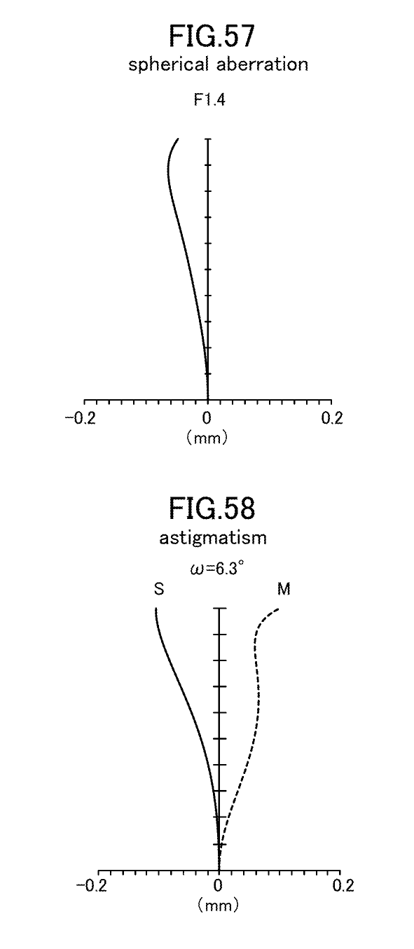

A graph of spherical aberration induced in the photographing lens system 1100 in the eleventh embodiment of the infrared camera apparatus is shown in FIG. 57, and FIG. 58 provides a graph of astigmatism induced therein.

### Embodiment 12

Optical performance of a photographing lens system 1200 incorporated in a twelfth embodiment of the infrared camera apparatus is provided in Table 33 corresponding to Table 1.

TABLE 33

| | |
|---|---|
| f | 100.0 |
| F | 1.0 |
| 2ω | 6.3 |
| λ₀ | 10000 |

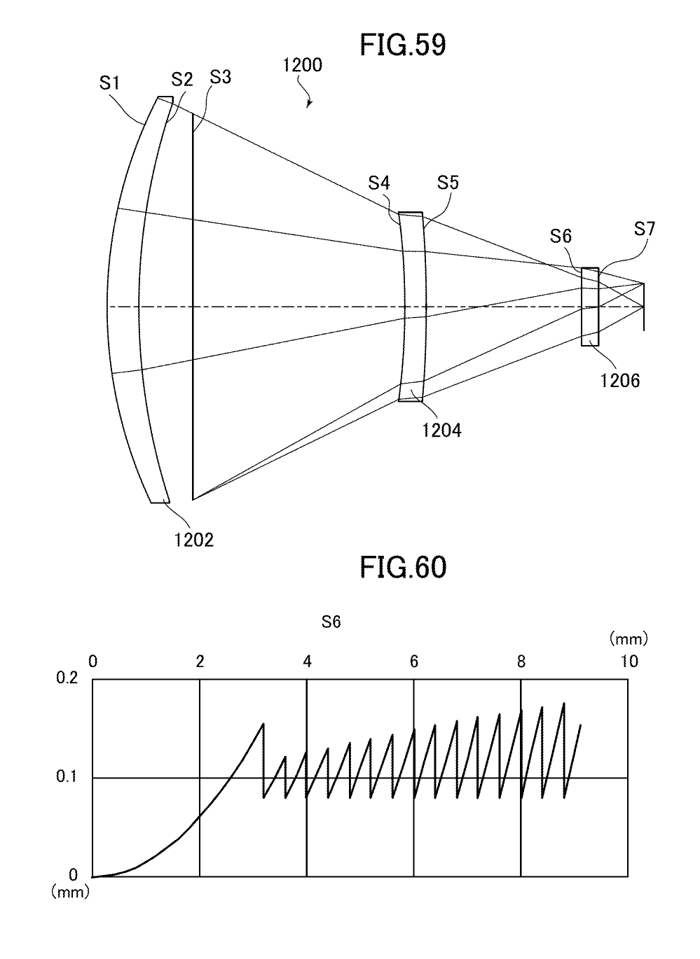

The photographing lens system 1200 in the twelfth embodiment of the infrared camera apparatus includes, as shown in FIG. 59, a spherical lens 1202 of positive refractivity having its opposite sides respectively formed in spherical surfaces S1 and S2, a Fresnel lens 1204 of negative refractivity having its opposite sides respectively formed in aspherical surfaces S4 and S5, and a Fresnel lens 1206 of positive refractivity having its opposites sides respectively formed in Fresnel aspherical surfaces S6 and S7. A substance of which the lens 1204 is made is chalcogenide.

Each of the Fresnel aspherical surfaces S6 and S7 is provided with concentric annular Fresnel lens facets among which those within the centered zone covering 75% of the effective aperture of the Fresnel lens are greater in the radial average width than the remaining annular Fresnel lens facets in the surrounding zone.

Data of the optical parameters of the photographing lens system 1200 in the twelfth embodiment of the infrared camera apparatus is given in Tale 34.

TABLE 34

| Surface | | Radius of | Distance btw. |
|---|---|---|---|
| Num | | Curvature (mm) | Surfaces (mm) |
| S1 | 1st Surface of 1st Lens | 107.000 | 7.420 |
| S2 | 2nd Surface of 1st Lens | 147.600 | 12.602 |
| S3 | Aperture Stop | Inf. | 49.495 |
| S4 | 1st Surface of 2nd Lens | −190.566 | 5.000 |
| S5 | 2nd Surface of 2nd Lens | −338.366 | 36.255 |
| S6 | 1st Surface of 3rd Lens | 33.163 | 4.000 |
| S7 | 2nd Surface of 3rd Lens | 36.836 | |

Data of aspherical surface parameters of the aspherical surfaces S4 and S5, and the Fresnel aspherical surfaces S6 and S7 are provided in Table 35.

TABLE 35

| Surface | | | | | | |
|---|---|---|---|---|---|---|
| Num. | K | A | B | C | D | E |
| S4 | 51.75 | 0.000E+00 | −7.976E−07 | 3.490E−09 | −1.611E−12 | 2.428E−15 |
| S5 | 135.33 | 0.000E+00 | −1.450E−06 | 3.068E−09 | −7.645E−14 | −2.170E−15 |
| S6 | 0.00 | 0.000E+00 | 2.050E−06 | −2.091E−07 | 8.964E−10 | 0.000E+00 |
| S7 | 0.00 | 0.000E+00 | 6.338E−06 | −4.059E−07 | 2.229E−09 | 0.000E+00 |

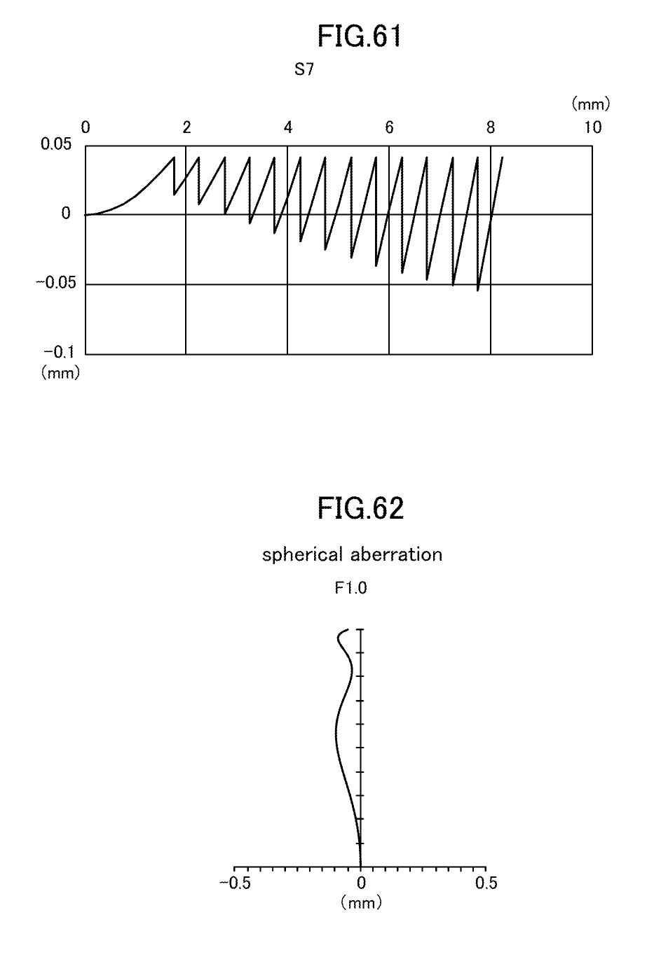

Cross sectional views of the Fresnel aspherical surfaces S6 and S7 are depicted in FIGS. 60 and 61, respectively.

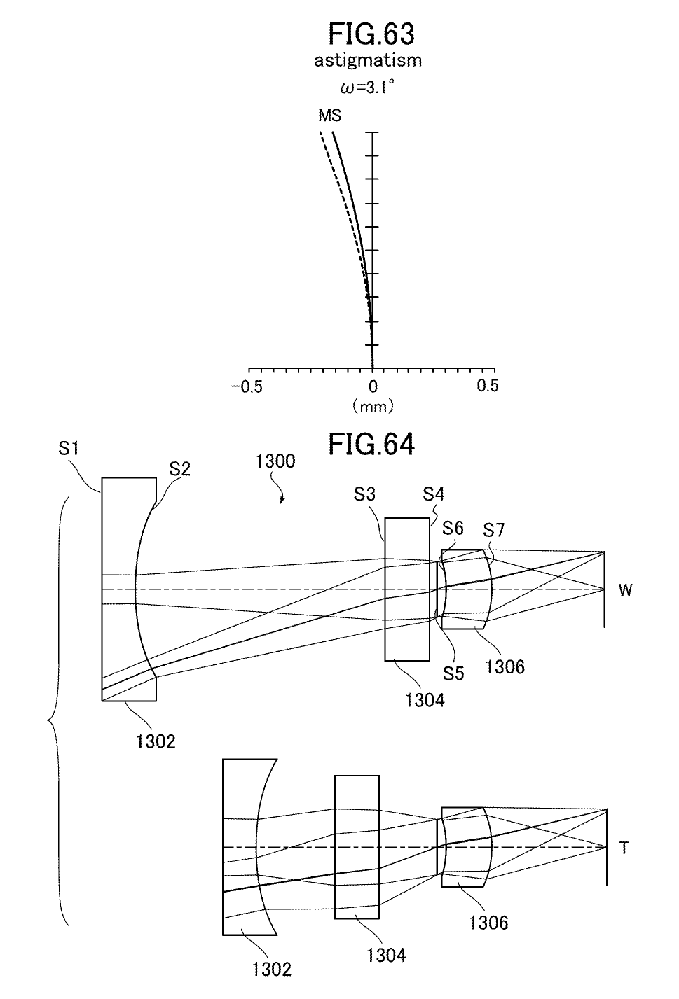

A graph of spherical aberration induced in the photographing lens system 1200 in the twelfth embodiment of the infrared camera apparatus is shown in FIG. 62, and FIG. 63 provides a graph of astigmatism induced therein.

### Embodiment 13

Optical performance of a photographing lens system 1300 incorporated in a thirteenth embodiment of the infrared camera apparatus is provided in Table 36 corresponding to Table 1.

TABLE 36

| | |
|---|---|
| f | 100.0 |
| F | 1.0 |
| 2ω | 6.3 |
| λ₀ | 10000 |

The photographing lens system 1300 in the thirteenth embodiment of the infrared camera apparatus includes, as shown in FIG. 64, a Fresnel diffraction lens 1302 of negative refractivity having its opposite sides respectively formed in a Fresnel aspherical surface S1 and a diffraction aspherical surface S2, a Fresnel diffraction lens 1304 of positive refractivity having its opposite sides respectively formed in a Fresnel aspherical surface S3 and a Fresnel diffraction aspherical surface S4, and a diffraction lens 1306 of positive refractivity having its opposite sides respectively formed in a diffraction aspherical surface S6 and an aspherical surface S7. A substance of which all the lenses 1302, 1304, and 1306 are made is chalcogenide.

Each of the Fresnel aspherical surfaces S1, S3 and S4 is provided with concentric annular Fresnel lens facets among which those within the centered zone covering 75% of the effective apertuer of the Fresnel lens are greater in the radial average width than the remaining annular Fresnel lens facets in the surrounding zone.

Data of the optical parameters of the photographing lens system 1300 in the thirteenth embodiment of the infrared camera apparatus is given in Table 37.

TABLE 37

| Surface | | Radius of | Distance btw. |
|---|---|---|---|
| Num | | Curvature (mm) | Surfaces (mm) |
| S1 | 1st Surface of 1st Lens | 974.168 | 30.132 |
| S2 | 2nd Surface of 1st Lens | 233.165 | (D1) |
| S3 | Aperture Stop | 220.406 | 40.176 |
| S4 | 1st Surface of 2nd Lens | −1034.187 | (D2) |
| S5 | 2nd Surface of 2nd Lens | Inf. | 8.190 |
| S6 | 1st Surface of 3rd Lens | −98.626 | 41.303 |
| S7 | 2nd Surface of 3rd Lens | −87.851 | |

Distances between the zooming-related lens pieces of the photographing lens system 1300 in the thirteenth embodiment of the infrared camera apparatus are shown in Table 38.

TABLE 38

| Distance btw. Surfaces (mm) | WIDE | TELE |
|---|---|---|
| D1 | 225.601 | 71.050 |
| D2 | 6.884 | 52.249 |

Aspherical factors of the photographing lens system 1300 in the thirteenth embodiment of the infrared camera apparatus is provided in Table 39.

TABLE 39

| Surface | | | | | | |
|---|---|---|---|---|---|---|
| Num. | K | A | B | C | D | E |
| S1 | −172.045 | 0.000E+00 | 1.073E−07 | −8.513E−12 | 2.665E−16 | 0.000E+00 |
| S2 | 4.549 | 0.000E+00 | 1.025E−07 | −7.680E−12 | −2.660E−16 | 0.000E+00 |
| S3 | 1.688 | 0.000E+00 | −1.416E−07 | −1.005E−11 | −1.070E−15 | 0.000E+00 |
| S4 | 78.125 | 0.000E+00 | −1.714E−07 | −3.610E−12 | 1.860E−16 | 0.000E+00 |
| S6 | −3.103 | 0.000E+00 | −1.186E−06 | 1.238E−10 | −6.518E−13 | 4.883E−16 |
| S7 | 0.454 | 0.000E+00 | −7.665E−08 | 6.530E−11 | −4.062E−14 | 1.006E−17 |

Diffraction grating coefficients of the photographing lens system 1300 in the thirteenth embodiment of the infrared camera apparatus are shown in Table 40.

TABLE 40

| Surface | | | |
|---|---|---|---|
| Num. | C1 | C2 | C3 |
| S2 | 7.395E−05 | 4.667E−09 | −7.604E−14 |
| S4 | −1.092E−04 | −8.556E−09 | 1.561E−12 |
| S6 | −7.525E−05 | 1.273E−08 | 3.004E−11 |

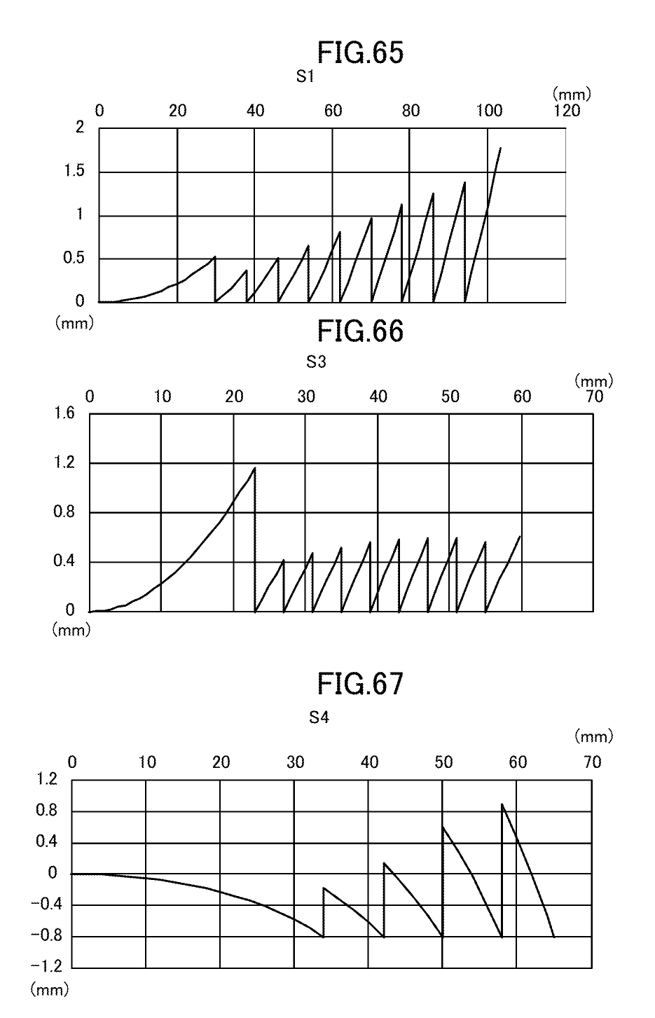

Cross sectional views of the Fresnel aspherical surfaces S1, S3 and S4 are shown in FIGS. 65, 66 and 67.

Each of the diffraction aspherical surfaces S2, S4 and S6 is designed to produce an optical path difference by a single wavelength between adjacent annular concentric facets serving as diffracting elements, depending upon an optical path difference function given by the following mathematical statement (II) and an amount of the substance machined away at a reference lens surface determined by the following mathematical statement (III):

Optical Path Difference Function

Ø(H)=C₁H²+C₂H⁴+C₃H⁶ (II)

Amount of the Substance Machined away at a Reference Lens Surface

$$L = \frac{∅ ( H ) - i λ}{n - 1} \\ i = 0 , 1 , 2 , 3 , … \qquad ( III )$$

where λ is a wavelength of infrared rays, n is a diffraction index, and H is a height of each of the facets serving as a diffracting element from the optical axis.

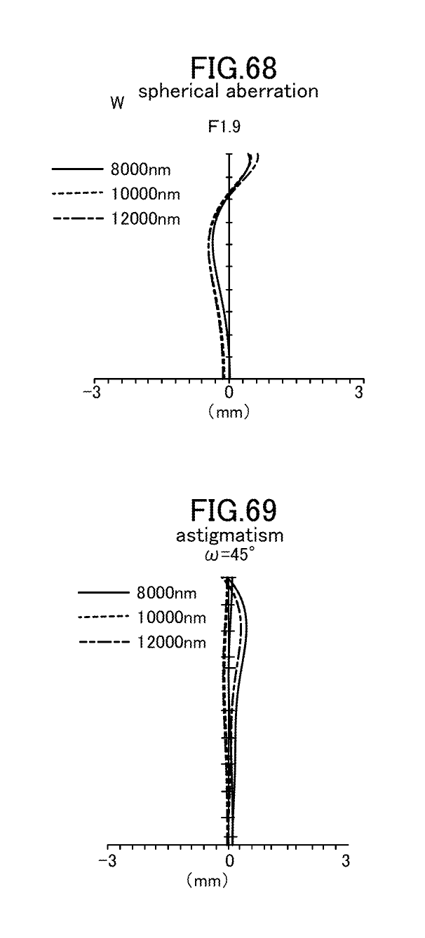

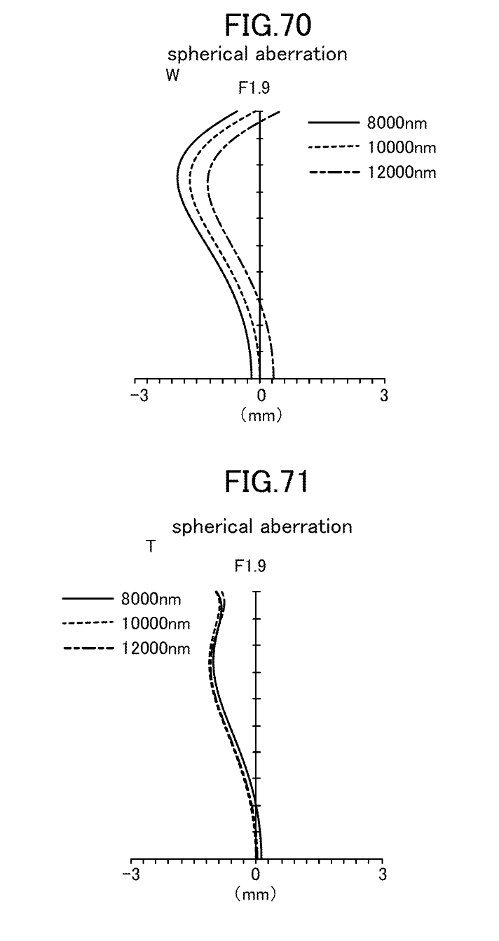

A graph of spherical aberration induced in the photographing lens system 1300 serving as a zoom lens in the thirteenth embodiment of the infrared camera apparatus is shown in FIG. 68, and FIG. 69 provides a graph of astigmatism induced therein. In FIGS. 68 and 69, alternate long and short dash line shows spherical aberration and astigmatism of the incident beams of 8000 nm wavelength while alternate long and two short dashes line shows the same aberrations of the incident beams of 12000 nm wavelength. FIG. 70 illustrates spherical aberration induced as a result of an optical modification where the diffraction aspherical surfaces S2, S4 and S6 are replaced with non-diffraction aspherical surfaces not machined to serve as diffracting elements.

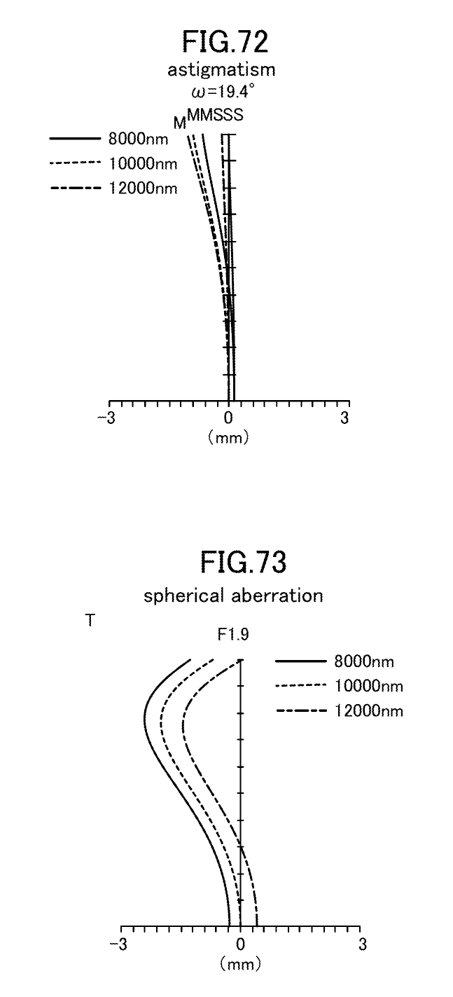

A graph of spherical aberration induced in the photographing lens system in focus at the telephotographing end during serving as a zoom lens in the thirteenth embodiment of the infrared camera apparatus is shown in FIG. 71, and FIG. 72 shows a graph of astigmatism therein. In FIGS. 71 and 72, alternate long and short dash line shows spherical aberration and astigmatism of the incident beams of 8000 nm wavelength while alternate long and two short dashes line shows those aberrations of the incident beams of 12000 nm wavelength. FIG. 73 illustrates spherical aberration induced as a result of an optical modification where the diffraction aspherical surfaces S2, S4 and S6 are replaced with non-diffraction aspherical surfaces not machined to serve as diffracting elements.

### Embodiment 14

Optical performance of a photographing lens system 1400 incorporated in a fourteenth embodiment of the infrared camera apparatus is provided in Table 41 corresponding to Table 1.

TABLE 41

| | WIDE | TELE |
|---|---|---|
| f | 33.4 | 100 |
| F | 1.9 | 1.9 |
| 2ω | 41.6 | 13.3 |

| | |
|---|---|
| λ₀ | 10000 |

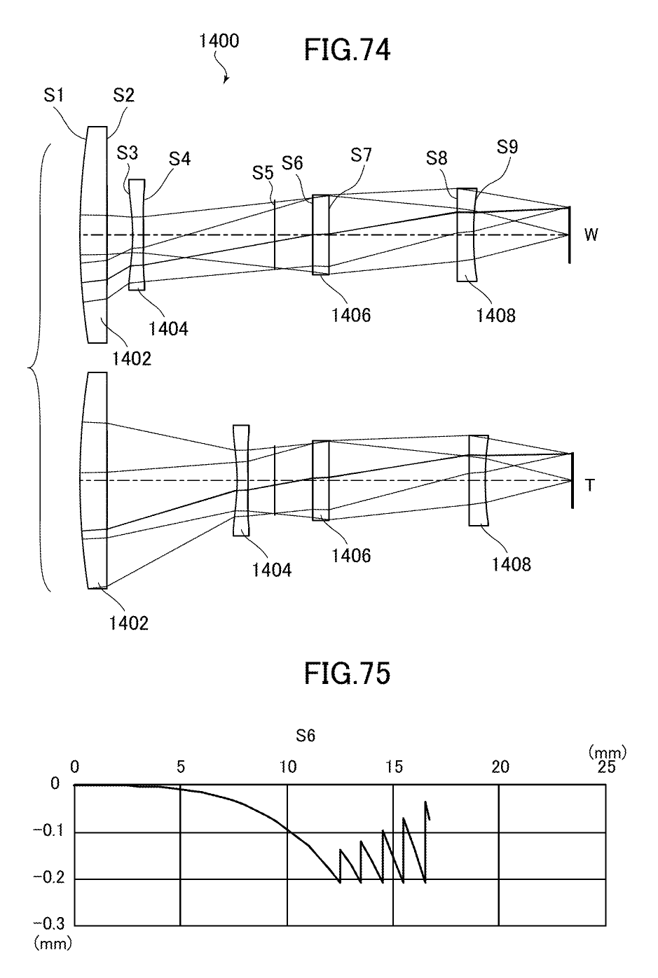

The photographing lens system 1400 in the fourteenth embodiment of the infrared camera apparatus includes, as shown in FIG. 74, an aspherical lens 1402 of positive refractivity having its opposite sides respectively formed in a spherical surface S1 and an aspherical surface S2, an aspherical lens 1404 of negative refractivity having its opposite sides respectively formed in aspherical surfaces S3 and S4, a Fresnel aspherical lens 1406 of positive refractivity having its opposite sides respectively formed in Fresnel aspherical surfaces S6 and S7, and a Fresnel aspherical lens 1408 of positive refractivity having its opposite sides respectively formed in a Fresnel aspherical surface S8 and an aspherical surface S9. A substance of which the lenses 1402, 1404, and 1406 are made is germanium. The lens 1408 alone is made of another substance of zinc selenide.

Each of the Fresnel aspherical surfaces S6, S7 and S8 is provided with concentric annular Fresnel lens facets among which those within the centered zone covering 75% of the effective apertuer of the Fresnel lens are greater in the radial average width than the remaining annular Fresnel lens facets in the surrounding zone.

Data of optical parameters of the photographing lens system 1400 in the fourteenth embodiment of the infrared camera apparatus is given in Tale 42.

TABLE 42

| Surface | | Radius of | Distance btw. |
|---|---|---|---|
| Num | | Curvature (mm) | Surfaces (mm) |
| S1 | 1st Surface of 1st Lens | 357.09 | 11.060 |
| S2 | 2nd Surface of 1st Lens | −8070.24 | (D1) |
| S3 | Aperture Stop | −94.52 | 4.424 |
| S4 | 1st Surface of 2nd Lens | −478.79 | (D2) |
| S5 | 2nd Surface of 2nd Lens | Inf. | 15.485 |
| S6 | 1st Surface of 3rd Lens | −4746.73 | 6.636 |
| S7 | 2nd Surface of 3rd Lens | −216.10 | (D3) |
| S8 | 1st Surface of 4th Lens | 64.89 | 6.636 |
| S9 | 2nd Surface of 4th Lens | 180.17 | |

Distances between the zooming-related lens pieces of the photographing lens system 1400 in the fourteenth embodiment of the infrared camera apparatus are shown in Table 43.

TABLE 43

| Distance btw. Surfaces (mm) | WIDE | TELE |
|---|---|---|
| D1 | 10.466 | 53.106 |
| D2 | 53.591 | 10.951 |
| D3 | 52.388 | 57.166 |

Aspherical factors of the photographing lens system 1400 in the fourteenth embodiment of the infrared camera apparatus is provided in Table 44.

TABLE 44

| Surface | | | | | | |
|---|---|---|---|---|---|---|
| Num. | K | A | B | C | D | E |
| S2 | −4.593 | 0.000E+00 | 2.794E−08 | −6.927E−12 | 2.678E−15 | −3.907E−19 |
| S3 | −10.470 | 0.000E+00 | 4.721E−06 | −4.513E−09 | 2.192E−13 | 6.176E−15 |
| S4 | −7.410 | 0.000E+00 | 5.249E−06 | −3.194E−09 | −2.561E−12 | 9.788E−15 |
| S6 | −7.388 | 0.000E+00 | −9.896E−06 | 2.389E−08 | −7.829E−11 | 6.813E−14 |
| S7 | 3.648 | 0.000E+00 | −9.245E−06 | 2.171E−08 | −6.242E−11 | 5.651E−14 |
| S8 | 7.193 | 0.000E+00 | 1.674E−06 | −1.314E−09 | −4.343E−12 | 1.385E−14 |

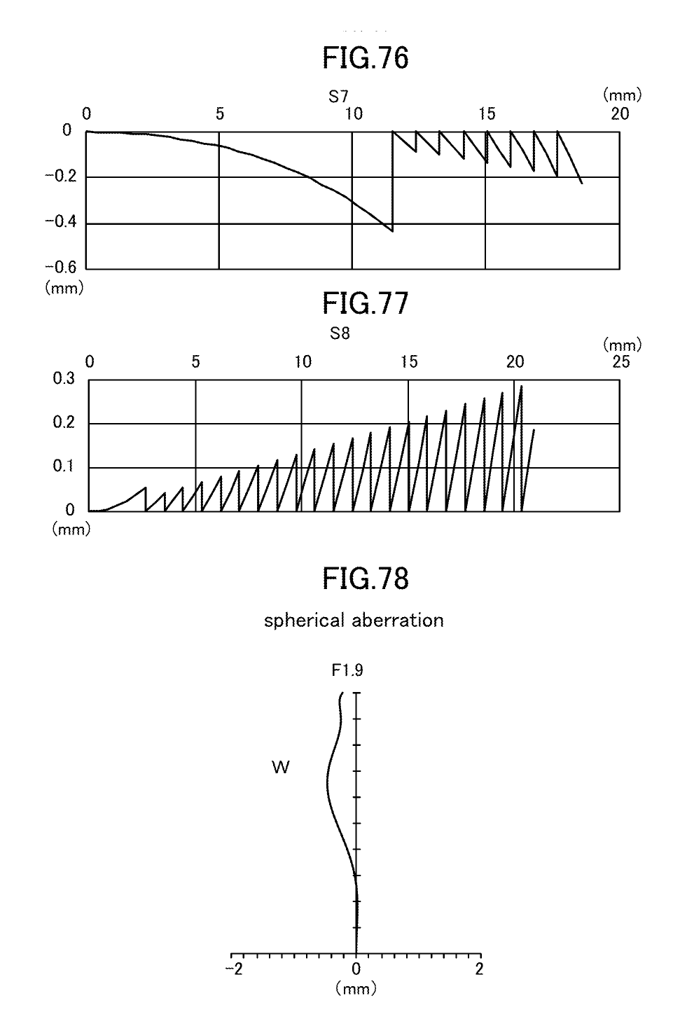

Cross sectional views of the Fresnel aspherical surfaces S6, S7 and S8 are depicted in FIGS. 75, 76 and 77, respectively.

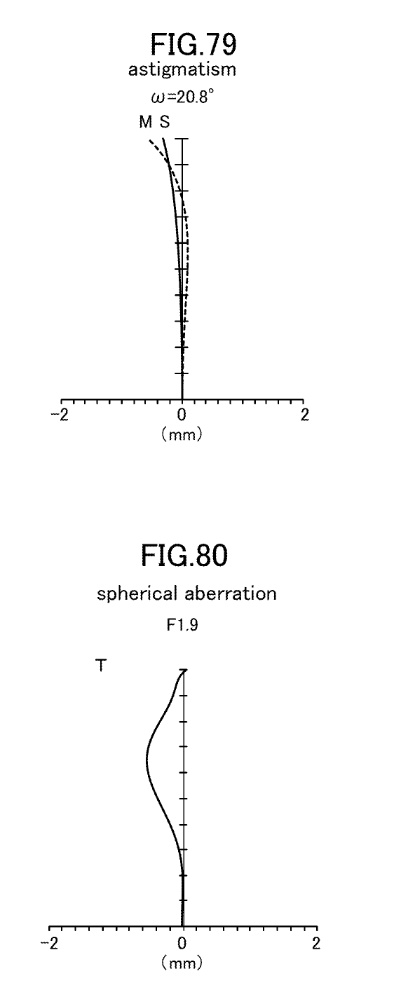

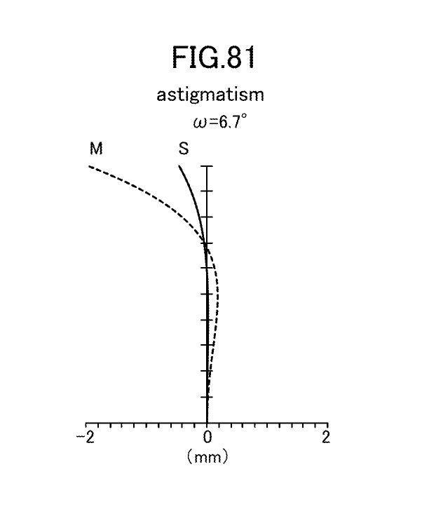

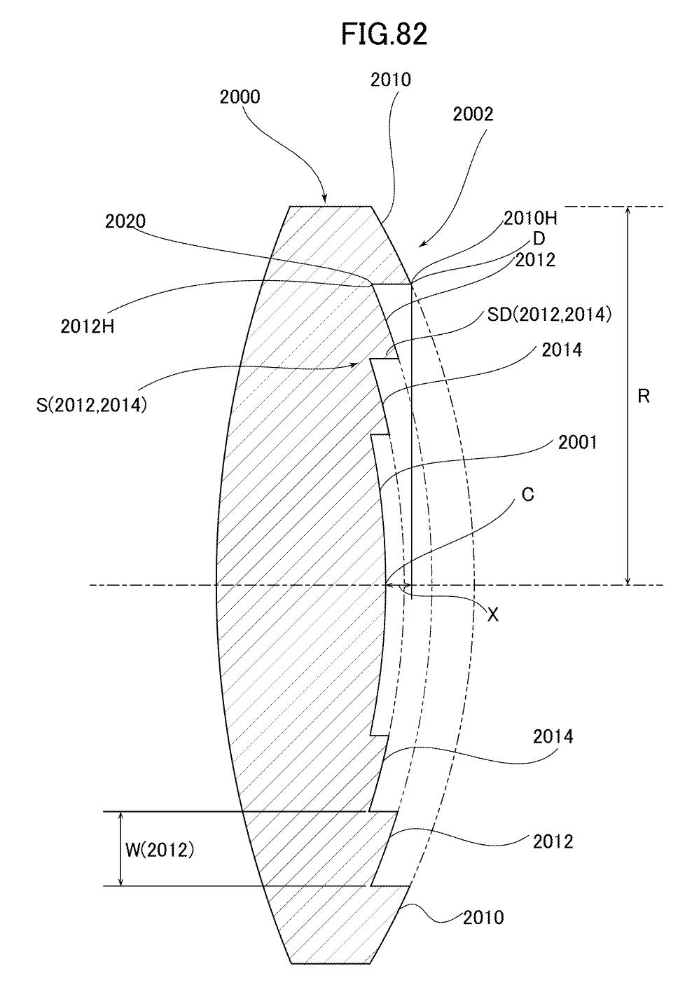

A graph of spherical aberration induced in the photographing lens system 1400 in focus at the wide-angle end during serving as a zoom lens in the fourteenth embodiment of the infrared camera apparatus is shown in FIG. 78, and FIG. 79 provides a graph of astigmatism induced therein. Similarly, a graph of spherical aberration induced in the same lens system in focus at the telephotographing end during the zooming is shown in FIG. 80, and FIG. 81 provides a graph of astigmatism induced therein.

Values substituted in the formulae in each of the embodiments are given in Table 45 below.

TABLE 45

| | Formula (1) in Claim 1 | | | | Formula (2) in Claim 2 | | | | Formula (3) in Claim 3 | | | | Claim 7 Inner Region of 75% | | | |
|---|---|---|---|---|---|---|---|---|---|---|---|---|---|---|---|---|
| | 5° ≦ θ° ≦ 65° | | | | \|X/R\| < 0.17 | | | | 0.7 < P/N < 0.17 | | | | or Less of the Effective Aperture | | | |
| | Fresnel | | Fresnel | | Fresnel | | Fresnel | | Fresnel | | Fresnel | | Fresnel | | Fresnel | |
| | Lens 1 | | Lens 2 | | Lens 1 | | Lens 2 | | Lens 1 | | Lens 2 | | Lens 1 | | Lens 2 | |
| | R1 | R2 | R1 | R2 | R1 | R2 | R1 | R2 | R1 | R2 | R1 | R2 | R1 | R2 | R1 | R2 |
| Embodiment 1 | 41.0 | 38.1 | | | 0.10 | 0.08 | | | 0.9 | 0.9 | | | 50% | 38% | | |
| Embodiment 2 | 40.3 | 44.4 | 8.6 | 19.7 | 0.16 | 0.05 | 0.01 | 0.02 | 1.0 | 1.0 | 1.0 | 1.0 | 42% | 22% | 46% | 43% |
| Embodiment 3 | | 9.2 | 5.6 | | | 0.01 | 0.00 | | | 1.0 | 1.0 | | | 57% | 49% | |
| Embodiment 4 | 31.6 | 27.2 | 32.5 | 34.2 | 0.05 | 0.07 | 0.02 | 0.05 | 1.0 | 1.0 | 1.1 | 1.1 | 43% | 30% | 38% | 19% |
| Embodiment 5 | 19.5 | 12.5 | | | 0.02 | 0.01 | | | 1.0 | 1.0 | | | | | | |
| Embodiment 6 | 15.4 | 10.5 | | | 0.03 | 0.02 | | | 1.1 | 0.9 | | | 32% | 35% | | |
| Embodiment 7 | | 46.8 | | | | 0.05 | | | | 0.9 | | | | 37% | | |
| Embodiment 8 | | 15.2 | | | | 0.02 | | | | 0.9 | | | | 16% | | |
| Embodiment 9 | 27.5 | 20.6 | | | 0.05 | 0.03 | | | 1.2 | 0.9 | | | 33% | 32% | | |
| Embodiment 10 | 14.3 | 11.4 | | | 0.004 | 0.02 | | | 1 | 1 | | | 17% | 42% | | |
| Embodiment 11 | | 5.9 | 7.3 | 8.6 | | 0.01 | 0.01 | 0.007 | | 0.8 | 1.0 | 1.0 | | 51% | 35% | 54% |
| Embodiment 12 | 14.1 | 11.1 | | | 0.02 | 0.01 | | | 1.2 | 0.9 | | | 35% | 21% | | |
| Embodiment 13 | 11.4 | | 6.4 | 15.6 | 0.02 | | 0.02 | 0.01 | 0.9 | | 1.4 | 0.9 | 29% | | 39% | 52% |
| Embodiment 14 | 9.1 | 14.1 | 18.9 | | 0.01 | 0.02 | 0.01 | | 1.2 | 1.1 | 1.0 | | 75% | 62% | 13% | |

What is claimed is:

1. An infrared camera apparatus, comprising
an infrared lens system having one or more Fresnel lens piece(s), each of the Fresnel lens pieces having at least one of its opposite sides formed in a Fresnel surface,
the Fresnel lens piece being made of a lens material of which transmissivity to light waves of one or more monowavelength(s) within an available wavelength range from 3000 nm to 14000 nm is 35% or higher when it takes a shape of 4-mm thickness uncoated parallel flat plate,
the maximum value of angle θ between lines normal to curved surfaces of the Fresnel surface and the optical axis of the Fresnel lens piece meeting the requirements defined in the formula as follows:
5°≦θ≦65°

2. The infrared camera apparatus according to claim 1, wherein the Fresnel surface(s) of the Fresnel lens piece(s) meets the requirements defined in the formula as follows:

|X/R|≦0.17
where R is a radius of an outer circle surrounding the outermost one of annular Fresnel lens facets concentrically divided in the Fresnel surface, and X is the maximum depth or distance in parallel with the optical axis from the center of the Fresnel surface to the farthest point therefrom or the peak of all peaks above interfaces between pairs of the adjacent annular Fresnel lens facets.

3. The infrared camera apparatus according to claim 1, wherein, in one or more of the Fresnel surfaces, 80% or more of the total number of the interfaces between pairs of the adjacent annular Fresnel lens facets meet the requirements as defined in the formula as follows:
0.7≦P/N≦1.3
where T_{MAX} is the maximum of all level differences in the interfaces, T_{MIN} is the minimum of all the level differences in the interfaces, P equals T_{MAX}/T_{MIN}, and N is an integer the closest to P.

4. The infrared camera apparatus according to claim 1, wherein the Fresnel lens piece(s) has its opposite sides respectively formed into the Fresnel surfaces.

5. The infrared camera apparatus according to claim 1, wherein, in the Fresnel surface(s), the annular Fresnel lens facets have different depths or distances in parallel with the optical axis from the center of the Fresnel surface to the peaks of the annular Fresnel lens facets, and the annular Fresnel lens facets of the radial widths greater than the average radial width of all the annular Fresnel lens facets are within a centered zone extending over 75% or less of the effective aperture of the Fresnel surface(s).

6. The infrared camera apparatus according to claim 1, wherein, in one or more of the Fresnel surfaces, 80% of the total number of the annular Fresnel lens facets have their radial widths sized to be 80 to 120% of the average radial width of all the annular Fresnel lens facets.

7. The infrared camera apparatus according to claim 1, wherein, in the Fresnel surface(s), the annular Fresnel lens facets of the radial widths greater than the average radial width of all the annular Fresnel lens facets are within a centered zone extending over 75% or less of the effective aperture of the Fresnel surface(s).

8. The infrared camera apparatus according to claim 1, wherein the infrared lens system includes a plurality of the Fresnel surfaces, and the radial width of the annular Fresnel lens facets varies from one Fresnel surface to another.

9. The infrared camera apparatus according to claim 1, wherein the Fresnel lens piece(s) is formed with integral diffraction optics.

10. A camera apparatus, comprising
a Fresnel lens piece having its Fresnel surface divided concentrically into annular Fresnel lens facets,
of all the annular Fresnel lens facets, the one of the greatest level difference in the direction in parallel with the optical axis between its inner and outer edges being within a centered zone extending over 75% of the effective aperture of the Fresnel lens piece, and 80% or more of the total number of interfaces between pairs of the adjacent annular Fresnel lens facets meet the requirements defined in the formula as follows:
0.7≦P/N≦1.3
where T_{MAX} is the maximum of all level differences in the interfaces, T_{MIN} is the minimum of all the level differences in the interfaces, P equals T_{MAX}/T_{MIN}, and N is an integer the closest to P.

11. The camera apparatus according to claim 10, wherein the Fresnel lens piece is made of a lens material of which transmissivity to light waves within a wavelength range from 3000 nm to 14000 nm is 35% or higher when it takes a shape of 4-mm thickness uncoated parallel flat plate.

12. The camera apparatus according to claim 10, wherein the Fresnel surface of the Fresnel lens piece meets the requirements defined in the formula as follows:

|X/R|≦0.17
where R is a radius of an outer circle surrounding the outermost one of the annular Fresnel lens facets concentrically divided in the Fresnel surface, and X is the maximum depth or distance in parallel with the optical axis from the center of the Fresnel surface to the farthest point therefrom or the peak of all peaks above the interfaces between pairs of the adjacent annular Fresnel lens facets.

13. The camera apparatus according to claim 10, wherein the Fresnel lens piece has its opposite sides respectively formed in curved surfaces.

14. The camera apparatus according to claim 10, wherein the Fresnel lens piece has curved surfaces on the opposite sides, and the maximum value of angle θ between lines normal to the curved surfaces and the optical axis of the Fresnel lens piece meets the requirements defined in the formula as follows:
5°≦θ≦65°
